(19) United States
(12) Patent Application Publication
(10) Pub. No.: US 2025/0139564 A1
(43) Pub. Date: May 1, 2025

(54) TEMPORAL PRESENTATION AND TRACKING OF ENTITY DATA

(71) Applicant: Treasury 4, Inc., Spokane, WA (US)

(72) Inventors: Edward Robert Barrie, Liberty Lake, WA (US); Steven Michael Helmbrecht, Spokane, WA (US); Nathan Leigh Brown, Liberty Lake, WA (US)

(21) Appl. No.: 18/385,235

(22) Filed: Oct. 30, 2023

(51) Int. Cl. G06Q 10/067; G06F 3/04847; G06Q 10/0635

(52) U.S. Cl. CPC G06Q 10/067; G06F 3/04847; G06Q 10/0635

(57) ABSTRACT

Techniques described herein include performing advanced data analytics based on disparate data sources in cloud computing environments. Cloud platform analytics system(s) associated with an organization may be implemented to retrieve organization-related data from various internal and/or external data sources. The cloud platform analytics systems may enrich and store the data within a cloud-based storage system, including structuring the data to perform specific organization management analytics. The various data analytics may be executed in the cloud environment using secure and performant analytics tools, and the results of the analytics processes may be output via reports, dashboards, notifications, and the like, to downstream systems and/or client devices.

### TECHNICAL FIELD

The present disclosure relates to cloud-based techniques for data ingestion, enrichment, and analytics from disparate data sources. In particular, techniques are described herein for structuring and building treasury systems in cloud computing environments, to support advanced analytics and provide robust treasury management solutions via a performant and secure platform.

### BACKGROUND

Large organizations may use automated tools and data analytics to implement organizational management solutions. For example, treasury systems of large organizations may include various proprietary solutions to perform cash and currency management functions, fund management, banking functions, and corporate finance. Such systems may be based on various data relating directly or indirectly to the organization, which is often stored on multiple disparate internal and external data storage systems. For instance, exposure risk analyses and other organizational management solutions may use data analytics tools based on a combination of organizational data stored in internal systems, technology and transaction partner data stored in various secure external systems, and public data sources stored in external open systems. These separate storage systems may separate new and/or legacy technologies for implementing data storage, data access, networking, security, analytics, and the like, which may create difficulties in managing and analyzing the data associated with the organization. For example, different internal and external systems may store and manage data differently, thus requiring significant manual efforts to retrieve, format, and aggregate the data into an accessible system. Further, the disparate storage of various types of organizational data on both external and internal systems, including entity data, account data, transaction data, and the like, often makes it difficult or impossible for conventional solution systems to leverage and analyze this data in a secure and performant manner.

### BRIEF DESCRIPTION OF THE DRAWINGS

The detailed description is described with reference to the accompanying figures. In the figures, the left-most digit(s) of a reference number identifies the figure in which the reference number first appears. The use of the same reference numbers in different figures indicates similar or identical components or features

FIG. 1 illustrates a computing environment including a treasury analytics cloud platform system, depicting components configured to interact with internal and external data sources, treasury data stores, client devices, and/or downstream systems, in accordance with one or more implementations of the disclosure.

FIG. 2 illustrates a data enrichment system configured to receive and enrich data from various organization systems and external data sources, in accordance with one or more implementations of the disclosure.

FIG. 3 illustrates example components within a treasury analytics cloud platform system, in accordance with one or more implementations of the disclosure.

FIG. 4A illustrates an example entity manager associated with a treasury analytics cloud platform system, in accordance with one or more implementations of the disclosure.

FIG. 4B illustrates an example data storage system that may be used by an entity manager associated with a treasury analytics cloud platform system, in accordance with one or more implementations of the disclosure.

FIG. 5A is a block diagram illustrating the physical and logical components of a special-purpose computer device within a cloud computing environment, according to one or more implementations of the disclosure.

FIG. 5B is a block diagram illustrating the physical and logical components of a special-purpose client device associated with a treasury analytics cloud platform system, according to one or more implementations of the disclosure.

FIGS. 6A-6E depict examples of an entity graph corresponding to different times and generated by a temporal entity tracking system, according to one or more implementations of the disclosure.

FIGS. 7A-7C depict examples of a node graph indicating relationships between entities and related entity attributes, according to one or more implementations of the disclosure.

FIG. 8 depicts an example automated data sharing system between an entity manager system and one or more financial institutions, according to one or more implementations of the disclosure.

FIG. 9 depicts an example entity calendar listing associated with a network of entities, according to one or more implementations of the disclosure.

FIG. 10 is a flow diagram illustrating an example process of receiving and enriching data from various data sources associated with a treasury analytics cloud platform system, according to one or more implementations of the disclosure.

FIG. 11 is a flow diagram illustrating an example process of executing exposure risk analytics associated with a treasury analytics cloud platform system, according to one or more implementations of the disclosure.

FIG. 12 is a flow diagram illustrating an example process of detecting and generating date-driven outputs associated with a treasury analytics cloud platform system, according to one or more implementations of the disclosure.

FIG. 13 illustrates an example system configured to execute cash management data analytics associated with a treasury analytics cloud platform system, according to one or more implementations of the disclosure.

FIG. 14 illustrates an example system configured to execute foreign exchange data analytics associated with a treasury analytics cloud platform system, according to one or more implementations of the disclosure.

FIG. 15 illustrates an example entity manager including components configured to generate entity maps and account maps associated with an entity, in accordance with one or more implementations of the disclosure.

FIG. 16 depicts an example account map user interface associated with an entity, according to one or more implementations of the disclosure.

FIG. 17 depicts another example account map user interface for an entity, the user interface including a legend and temporal account map tracking, according to one or more implementations of the disclosure.

In the appended figures, similar components and/or features may have the same numerical reference label. Further, various components of the same type may be distinguished by following the reference label by a letter that distinguishes among the similar components and/or features. If only the first numerical reference label is used in the specification, the description is applicable to any one of the similar components and/or features having the same first numerical reference label irrespective of the letter suffix.

### DETAILED DESCRIPTION

Various techniques described herein relate to performing advanced analytics based on data retrieved and restructured from disparate data sources in cloud computing environments. In certain examples described herein, one or more cloud platform analytics systems associated with an organization may be implemented to retrieve organization-related data from various data sources internal and external to the organization. The cloud platform analytics systems may enrich and store the data within a cloud storage system, including structuring the data within the cloud storage to perform specific organization management analytics. Various organization-specific data analytics may be executed in the cloud environment, using secure and highly performant analytics tools, to perform organization-specific business intelligence (BI) and risk analysis assessments. The results of data analytics processes may be output via reports, dashboards, notifications, and the like, that may be provided to downstream systems and/or client devices.

Certain examples described herein relate to data analytics and other BI tools in the context of treasury systems of large organizations. For instance, certain examples describe performing analytics to determine metrics for exposure risks such as foreign exchange exposure, currency exposure, interest rate exposure, and the like. However, it can be understood from the context of this disclosure that the techniques described herein need not be limited to treasury systems, and similar or identical techniques may be used to implement other cloud-based analytics systems and/or organization management solutions. Within the field of exposure risk analytics and/or other technical fields, the techniques described herein provide advantages and improved operation of systems that retrieve data from one or more disparate data storage systems, enrich and structure the data in a cloud storage environment, and execute analytics or other advanced BI tools on the data.

A treasury system within an organization may implement various tools and functionalities to track, manage, store, and ensure the proper use of the assets of the organization. Examples of assets of an organization may include physical assets, such as real estate, oil, precious metals, etc., as well as financial assets, such as cash, currency, cryptocurrency, liquid funds, stocks, bonds, receivables, etc. Treasury systems may implement specialized data analytics and/or other tools configured to perform asset management tasks, analyze risk, and perform other treasury-related tasks, such as cash and currency management, fund management, banking, corporate finance, etc.

For the treasury systems of an organization, performing analytics and other treasury-related functionality can be made more difficult when the underlying data needed for the analyses are owned and/or stored by separate entities within the organization or remote systems outside of the organization. For instance, some treasury systems may use organization asset data stored by financial institutions, corporate record databases, currency exchanges, market data sources, and the like, which may be distributed across multiple disparate storage systems. As an example, to perform an exposure risk analysis for an organization, an analytics system or BI tool of a treasury system may retrieve and use data from various internal systems of the organization (e.g., accounting systems, transaction systems, human resources systems, etc.), as well as a number of remote systems external to the organization (e.g., financial institution systems, currency exchange systems, market data providers, etc.). These disparate data systems may use different technologies for data storage and access, including different data structures, schema, and storage technologies, as well as different data formats, different network and security techniques, and different sets of data management and analysis tools. Additionally, in some cases the data systems of external financial institutions, transaction systems, and the like, may store confidential or sensitive for multiple different organizations within the same data stores and/or networks.

Accordingly, for some conventional treasury systems, the data retrieval, analysis, and editing required to perform exposure risk analytics and/or other treasury data analyses can make those processes error-prone and inefficient. For instance, to execute a treasury data analytics tool, a conventional treasury system may be required to access multiple data stores using different combinations of data access technologies, security authentication, and/or data formats. These technologies can include legacy storage systems and other tools that may be incompatible with other external systems or the internal systems of the organization. Therefore, after retrieving the data from the disparate sources, the treasury system may be required to parse, clean, and enrich the data, and then determine associations between data imported from the different data sources.

As a result, conventional treasury systems often have limitations in the types of analytics and other data analysis tools that are executed on the systems. Because conventional systems may have to rely on incomplete or less current data from their data sources, the various analytics and tools executed by those systems may provide inaccurate and less useful analysis. The data analytics and other tools used by conventional systems also may be too slow and inefficient to be leveraged in real-time or other time-sensitive applications such as notifications, dashboards, and other interactive interfaces with clients or downstream systems. Additionally, the underlying data retrieved by conventional treasury systems can be dated, limiting the reliability of the analysis based on the data. In other cases, the disparate systems storing treasury-related data for an organization might not retain historical data beyond a certain time period, thereby preventing the treasury system of the organization from performing in-depth historical analyses that compare past and present data metrics.

To address the technical issues and other deficiencies with conventional treasury systems, the techniques described herein provide improvements that allow for more robust, accurate, and timely analytics and other data analyses in treasury systems. As described below in more detail, the techniques herein include improvements in the techniques and timing used to retrieve treasury-related data for an organization from a number of disparate data sources. Additional techniques described herein relate to enrichment and storage of treasury-related data. In various examples, particular data enrichment tools and processes may be used for specific types of treasury data, from specific source systems, and/or associated with particular entities/organizations. As a result, related data pools that can be used as input for treasury system data analytics and other functionality can be retrieved, enriched, associated, and stored more quickly and efficiently, and without time-consuming manual processes.

Additional techniques described herein relate to structuring and organizing the data within the cloud-based storage platform, using treasury-centric schema and structures that are more readily compatible with the data analytics and other treasury system functionality. For instance, treasury-related data from disparate data sources can be structured based on the inputs for exposure risk analytics tools and/or any other BI tool used by the treasury system. The use of cloud-based storage systems to store the enriched and aggregated treasury data may provide data security and segregation of sensitive and/or confidential data. Additionally, the treasury data stored with the cloud storage can be configured to seamlessly receive updated data as it becomes available from various disparate data sources. In some examples, a cloud-based treasury data store may be configured to incorporate new data, archive old data, and automatically rerun various analytics on the updated data. Archived treasury data may be retained in the cloud storage, in the same structure and/or format, to support analytics on historical data and time-based comparisons between past and current states of the organization. The treasury data also may be partitioned and/or otherwise structured within the cloud storage into data subsets based on time periods, and/or based organization entities such as departments or corporate subsidiaries. Storing the treasury data in these subdivided structures may allow the analytics and other functionality of the treasury system to be executed seamlessly on different portions of the data for a more robust and detailed analysis.

Still further techniques and improvements described herein include tools and functionality for providing output data based on the treasury system data analytics. For example, different types of outputs can include interactive dashboards, reporting and support platforms, task engines, notifications, recommendation engines, and the like. Some outputs can be provided based on the results of data analytics or BI tools meeting or exceeding certain criteria. For example, when an exposure risk metric determined by a treasury data analytics process exceeds a risk threshold, the output components may trigger a dashboard creation process, notifications to key individuals with recommendations, report generation, etc. The output components of the cloud-based treasury system can be configured to provide outputs, via tasks, notifications, reports, dashboards, etc., to different users and/or different target systems, based on the results of particular analytics or BI tools.

As described in more detail below, the various features and implementations of the treasury analytics cloud platform system(s) provide technical advantages over conventional treasury systems. For example, by using the techniques described herein for retrieving organization-related treasury data from disparate data sources, enriching and using a treasury-centric structure and format to store the data in a cloud-based storage system, the treasury analytics cloud platform system(s) may provide more robust, accurate, and timely data analytics and BI operations. For instance, the treasury data analytics and/or BI operations may provide improved assessments of an organization's exposure risks, including more accurate and apportionable risk assessment data, based on underlying data that is more current and relevant. Although certain examples herein relate to cloud-based treasury systems that use analytics to determine exposure risks, it can be understood from the context of this disclosure that similar or identical techniques can be used to execute any other analytics and/or BI tools for improved organization management.

For example, the cloud platform system(s) described herein also may be implemented to execute data analytics and tools designed to perform legal entity management functionality. For instance, the systems may implement heuristics-based algorithms and/or trained machine-learned models configured to manage various types of legal entity data (e.g., legal, tax, treasury, internal auditing, account, procurement, etc.), and legal entity events (e.g., registrations tracking, beneficial ownership, bank accounts, signatories, officers and directors, renewals, document management, etc.).

Additionally, in some cases the cloud platform system(s) described herein may be implemented to execute data analytics and tools for performing cash management functionality for the organization, including cash tracking and/or monitoring, including but not limited to dynamic analytics on various segments of cash flow. In various other examples, the cloud platform system(s) described herein also may be implemented to execute tools and analytics for managing and improving short-term treasury forecasts (e.g., foreign exchange forecasts, cash forecasts, etc.). In such examples, the cloud platform system(s) may incorporate machine learning models and may utilize customizable suites of artificial intelligence (AI) algorithms. The cloud platform system(s) may consolidate the critical inputs provided to AI or ML-based forecasting processes, and may provide feedback identifying sources of historical forecast variance. In still other examples, the cloud platform system(s) described herein may be implemented to execute analytics and tools for foreign exchange rate management for the organization. For instance, the cloud platform system(s) may include analytics and tools to measure, monitor, and mitigate exchange rate volatility. In such systems, the analytics and tools of the system may integrate with trading platforms of the organization to capture any combination of data associated with trades, confirmations, and/or settlements. The analytics and tools in these examples may provide differentiation capability, including a full deconstruction of foreign exchange gain/loss results along user-defined dimensions over any period of time.

Further, as noted above, although the above examples relate to implementing cloud platform system(s) to execute treasury analytics and BI tools, in other examples cloud platform system(s) may be similarly implemented to perform any other type of analytics or tools for organization management. For instance, similar cloud platform system(s) may be implemented to retrieve data and execute analytics and tools to analyze and increase customer retention for the organization, to create marketing campaigns, to perform risk management assessments in various contexts (e.g., treasury and no-treasury related risks), to manage supply chains, etc. For treasury analytics cloud platform system(s) and/or the various other types of cloud platform system(s) described herein, these techniques may provide advantages of more accurate, robust, and timely analytics.

In the following descriptions of the figures, for the purposes of explanation, specific details are set forth in order to provide a thorough understanding of various implementations and examples. It will be apparent, however, that various implementations may be practiced without these specific details. For example, circuits, systems, algorithms, structures, techniques, networks, processes, and other components may be shown as components in block diagram form in order not to obscure the implementations in unnecessary detail. The figures and description are not intended to be restrictive.

Some examples, such as those disclosed with respect to the figures in this disclosure, may be described as a process depicted as a flowchart, a flow diagram, a data flow diagram, a structure diagram, a sequence diagram, or a block diagram. Although a sequence diagram or a flowchart may describe the operations as a sequential process, many of the operations may be performed in parallel or concurrently. In addition, the order of the operations may be re-arranged. A process is terminated when its operations are completed but could have additional steps not included in a figure. A process may correspond to a method, a function, a procedure, a subroutine, a subprogram, etc. When a process corresponds to a function, its termination may correspond to a return of the function to the calling function or the main function.

The processes depicted herein, such as those described with reference to the figures in this disclosure, may be implemented in software (e.g., code, instructions, program) executed by one or more processing units (e.g., processors cores), hardware, or combinations thereof. The software may be stored in a memory (e.g., on a memory device, on a non-transitory computer-readable storage medium). In some examples, the processes depicted in sequence diagrams and flowcharts herein can be implemented by any of the systems disclosed herein. The particular series of processing operations (or steps) in this disclosure are not intended to be limiting. Other sequences of operations may also be performed according to alternative examples. For example, alternative examples of the present disclosure may perform the operations outlined above in a different order. Moreover, the individual operations illustrated in the figures may include multiple sub-steps that may be performed in various sequences as appropriate to the individual operation. Furthermore, additional operations may be added or removed depending on the particular applications. One of ordinary skill in the art would recognize many variations, modifications, and alternatives.

In some examples, each process in the figures of this disclosure can be performed by one or more processing units. A processing unit may include one or more processors, including single core or multicore processors, one or more cores of processors, or combinations thereof. In some examples, a processing unit can include one or more special-purpose co-processors such as graphics processors, Digital Signal Processors (DSPs), or the like. In some examples, some or all of the processing units can be implemented using customized circuits, such as Application Specific Integrated Circuits (ASICs), or Field programmable gate arrays (FPGAs).

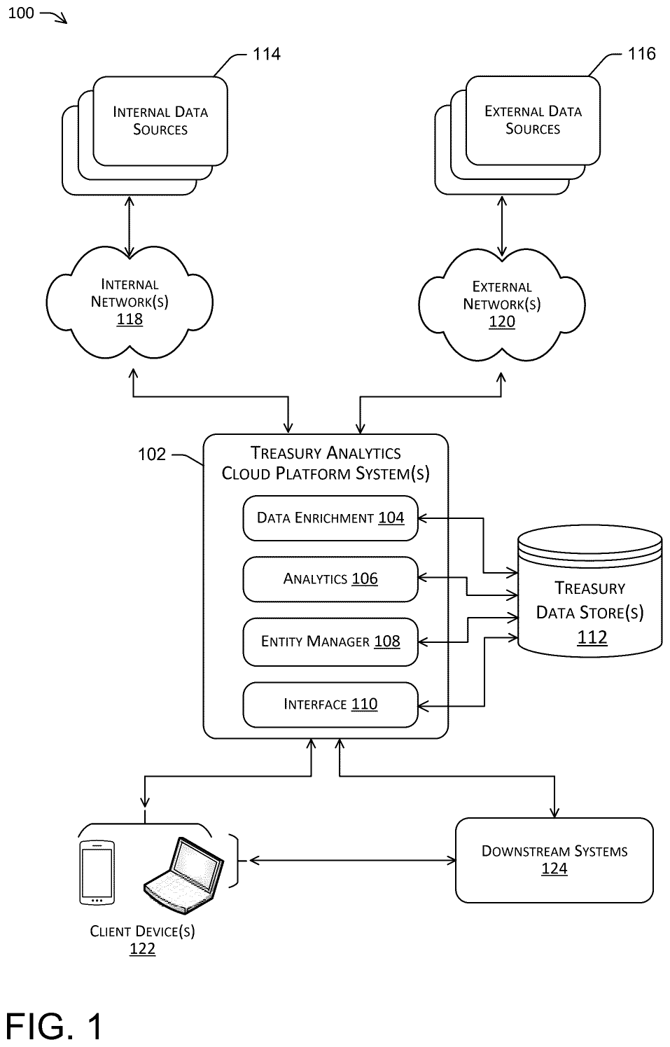

FIG. 1 shows an example computing environment 100 including a treasury analytics cloud platform system 102 (which also may be referred to a cloud-based treasury system 102), including various components configured to receive and enrich data from internal and external data sources, and execute treasury system analytics and tools based on the data. The cloud-based treasury system 102 may include components configured to perform various functionality related to retrieving treasury data from disparate data sources and systems, modifying and/or restructuring the data, and analyzing the data to determine exposure risk data or other treasury-related organization management metrics. For instance, the data enrichment component 104 (which also may be referred to as a data enrichment system 104) may be configured to receive, analyze, and modify data from various data sources. The analytics component 106 may be configured to execute various data analysis tools on the organization's treasury data. The entity manager component 108 may be configured to track and manage entity-related data for the internal and/or external legal entities associated with the organization. The interface component 110 may include functionality to provide outputs to client devices or other downstream cloud systems, based on the outputs of the analytics component 106 and/or entity manager component 108.

Additionally, as shown in this example, the treasury data store(s) 112 may include storage components configured to store the raw data and/or enriched data received from the data sources associated with the organization. In some examples, the treasury data store(s) 112 may be implemented as a cloud-based storage system, and/or as a secure storage within a datacenter of the organization. Cloud-based implementations may provide advantages in some cases for the treasury data store(s) 112, including data scalability and portability, data segregation based on entity, data migration and replication, etc. In some cases, treasury data store(s) 112 may partition and/or backup aggregations of treasury data based on time, which may allow the cloud-based treasury system 102 to perform similar or identical analytics on the current data state of the organization, and/or based on previous data states.

In various implementations, the cloud-based treasury system 102 may be implemented within a public cloud, a private cloud, and/or hybrid cloud infrastructure. In such examples, the cloud-based treasury system 102 may be implemented and operated within a network of servers hosted remotely, rather than on the servers or computing systems run by the organization. In other examples, cloud-based implementations need not be used, and similar or identical treasury systems may be built use on-premise computing infrastructures (e.g., datacenters) associated with the organization. In some cases, the cloud-based treasury system 102 may include a combination of multiple cloud networks, and/or a combination of cloud-based and non-cloud networks. For instance, an organization may allocate an on-premise computing infrastructure for storing and/or processing certain private and secure treasury data, while a public cloud infrastructure is used for storing and processing other non-secure treasury data. Accordingly, the computing environment 100 may include multi-cloud (or multi-infrastructure) environments, such as hybrid clouds environments, multi-datacenter environments, multi-edge environments, etc. Such multiple-cloud or multi-infrastructure environments may provide architectural flexibility and scalability with respect to capturing and processing treasury data, and may allow for the integration of specialized (e.g., organization-specific) analytics and models.

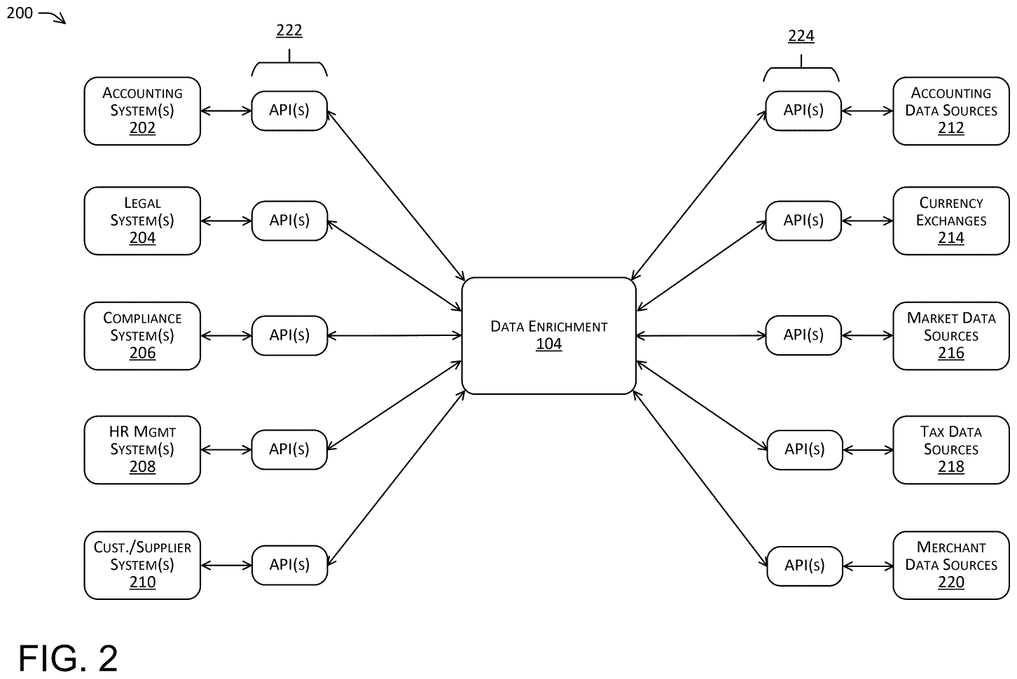

The cloud-based treasury system 102 may receive treasury-related data (also referred to herein as treasury data) from a number of different data sources. Examples of various data sources that may provide treasury data for an organization are described in more detail below in reference to FIG. 2. As shown in this example, data sources for treasury data may include one or more internal data sources 114 as well as one or more external data sources 116. As used herein, an internal data source 114 may refer to a computing system operated by the organization, and internal data may refer to data stored and/or owned by the organization. Although the internal data sources 114 may be owned and/or controlled by the organization, it can be understood that different internal data sources 114 may be associated with different entities (e.g., departments, subsidiaries, etc.) within the organization, and/or may be operated within different computing infrastructures of the organization (e.g., networks, datacenters, etc.). In contrast, an external data source 116 may refer to a remote system owned and operated by an entity separate from the organization, such as a financial institution, a transaction system, a counterparty computer system, and/or various public data source systems.

The cloud-based treasury system 102 may use different networks and/or different network access technologies to connect to and retrieve data from the internal data sources 114 and external data sources 116. In some implementations, one or more internal data sources 114 may reside within a server or datacenter operated by the organization, and/or within a cloud-based system of the organization. In such cases, the cloud-based treasury system 102 may communicate with the internal data sources 114 via internal networks 118, such as a secure private network (e.g., a private LAN) or secure corporate network protected by a firewall. In other cases, for other internal data sources 114 distributed across multiple cloud systems, servers, and/or data centers, the cloud-based treasury system 102 may use various secure private networks and/or via unsecure public networks (e.g., the Internet) including tunneling and encryption technologies. For accessing external data sources 116 to retrieve data, the cloud-based treasury system 102 may use application programming interfaces (APIs) and/or various other data transfer technologies, such as a secure file transfers protocol (SFTP), flat-file integration, web scraping tools (for web-based data sources), etc. Using these and other data transfer technologies, the cloud-based treasury system 102 may communicate with the internal and external data sources via internal networks 118 and external networks 120, which may include communication networks including but not limited to computer networks (e.g., TCP/IP networks, etc.), wireless networks (e.g., Long-Term Evolution (LTE), 5G, a Universal Mobile Telecommunications Service (UMTS), Global System for Mobile communications (GSM) networks, etc.), satellite networks, and the like.

As described below in more detail, the cloud-based treasury system 102 may be designed to provide data to various different client devices 122 and/or downstream systems 124, based on the outputs of data analytics and/or BI tools executed by the analytics component 106, and/or outputs from the entity manager component 108. For instance, the interface component 110 may implement functionality to allow client devices 122 to interact directly or indirectly with the analytics component 106, via reports, dashboards, notifications, task engines, and/or recommendations, based on the outputs of the analytics component 106. Additionally or alternatively, the interface component 110 may implement functionality to provide data analytics data, outputs from BI tools, and/or entity data to downstream systems 124, which may include downstream analytics systems within the organization and/or computing systems of separate entities such as partner organizations, suppliers, transaction counterparties, etc.

FIG. 2 shows another computing environment 200, including a data enrichment component 104 (or data enrichment system 104) configured to receive, enrich, and store organization-related and/or treasury-related data from various internal systems and external data sources. In some examples, the data enrichment system 104 may include networking and/or interface components configured to connect to the data sources, authenticate on behalf of the organization (e.g., for secure external sources), and to request and retrieve the data. In other examples, this functionality may be performed by a separate data retrieval (or data ingestion) component, which may retrieve data from the various data sources, parse and/or format the data, and then provide the data to the data enrichment system 104.

Various different examples of possible data sources are described below, from which the data enrichment system 104 may receive treasury-related data associated with an organization. It can be understood that these example data sources are illustrative and not limiting, and that in other examples any other type of organization data may be received from other internal or external data sources. The combined data from these various data sources may represent a financial (or treasury) ecosystem for the organization, including organization data generated and managed by the organization itself, aggregated with additional organization-related data generated and managed by external third-party systems.

The data enrichment system 104 may receive the various financial and/or treasury-related data from the data sources 202-220, and may execute one or more automated processes to parse, analyze, and enrich the data before storing the enriched data in the treasury data store(s) 112. In some cases, the automated processes performed by the data enrichment system 104 may include executing an automated data extraction tool (e.g., using or in conjunction with the APIs 22-224), determining identifiers and/or security credentials associated with the organization, and then providing the security credentials to the data extraction tool to perform the data importation from the data sources 202-220. Additional automated processes identifying data associated with the organization and/or excluding additional data not associated with the organization. For example, as noted above, some external data sources 212 may store financial/treasury associated with multiple different organizations. In such cases, the data enrichment system 104 may be configured to request data batches from data source(s) corresponding to a time period, geographic region, account or account type, etc., and then parse and extract out data that is not applicable to the organization.

In various other examples, the data enrichment system 104 may execute transformation processes to analyze and modify data with supplemental information. For instance, the data enrichment system 104 may execute rules-based algorithms or trained machine-learned models to process an input data item (or data object) and classify/categorize the data items. For instance, the data enrichment system 104 may implement algorithms and/or trained models to analyze text descriptions or other natural language input associated with transactions, to classify the transactions into classification values representing transaction types and/or category. In other examples, the data enrichment system 104 may execute algorithms and/or trained models based on text descriptions, metadata, and/or any other combination of data fields, to determine (or predict) additional data associated with the received data items. The determinations and/or predictions made during data enrichment may include linking, or determining an association between data items and entities (e.g., individuals or other legal entities, etc.), accounts, transactions, departments, currencies, and/or other data items.

In some cases, associations may be determined for corresponding data items in different systems, and the data enrichment system 104 may create data fields to represent the association. For instance, a single object or entity (e.g., individual, account, legal entity, transaction, etc.) may have different identifiers used in different data source systems. In various examples, the data enrichment system 104 may determine matching or corresponding identifiers representing the same data objects or entities within different data systems. These cross-system matching or corresponding identifiers can be used to enrich the data by updating or replacing data fields to use consistent data identifiers, and/or by linking or associating different identifiers (e.g. via dependencies) to cross-reference the data within the treasury data store(s) 112.

Accounting system(s) 202 may include one or more internal systems of the organization configured to store accounting data. Accounting system(s) 202 may be implemented using enterprise resource planning (ERP) technologies in some examples. ERP systems and/or other types of accounting system(s) 202 may be configured to store and manage, for example, planning data, sales data, credit data, procurement data, control/audit data, etc. The data enrichment system 104 may retrieve from an ERP system and/or other types of accounting system(s) 202, data including (but not limited to) accounting foreign exchange rates, general ledger (G/L) charts of account definitions and attributes, G/L CoA mapping data, G/L foreign currency remeasurement and/or revaluation rules, balance sheet amounts in functional and transaction currency, journal entries in functional and transaction currency, intercompany invoices, cash management and bank account reconciliation data, and/or company/entity configuration data. Additional examples of data that the data enrichment system 104 may request and retrieve from the accounting system(s) 202 may include accounting balance sheet foreign exchange rules, accounting income statements accrual rates, accounting consolidation and transaction rates, equity and other accounting rates, balance sheet accounts in functional and transaction currency (e.g., by entity and period), income statement accounts in functional and transaction currency (e.g., by entity and period), etc.

Legal system(s) 204 may include one or more internal systems of the organization configured to store legal/entity data related to the organization, subsidiaries, and/or parent companies thereof. The data enrichment system 104 may retrieve various types of legal and entity-related data from the legal system(s) 204, including but not limited to, organizational structure diagrams/schematics for the organization and/or subsidiaries, intercompany terms and conditions regarding document management, employee stock purchase plan (ESPP) program profiles, restricted stock unit (RSU) program profiles, payroll program profiles, statutory program, ownership profiles and ultimate beneficial owner profiles, tax management profiles, tax registration identifiers, and listings of officers, directors, key control persons, etc.

Compliance system(s) 206 may include one or more internal systems of the organization configured to compliance data associated with the organization. Examples of compliance systems 206 may include various know your customer (KYC), know your business (KYB), and know your product (KYP) services. The data enrichment system 104 may retrieve various types of compliance-related data associated with the organization, from the compliance system(s) 206, including but not limited to, derivatives and regulatory compliance data, anti-money laundering compliance data, payments and sanctions data, etc.

Human resources (HR) system(s) 208 may include one or more internal systems of the organization configured to store HR data related to the organization, subsidiaries, and/or parent companies thereof. The data enrichment system 104 may retrieve various types of HR data from the HR system(s) 208, including but not limited to summary payroll amounts, payroll tax data, 401K contributions, flexible spending account (FSA) contributions, health saving account (HSA) contributions, ESPP cash transfers, stock option and RSU exercises, etc.

Customer and/or supplier systems(s) 210 may include one or a combination of internal systems storing the customer data and/or supplier data for the organization, subsidiaries, and/or parent companies thereof. The data enrichment system 104 may retrieve various types of customer and supplier data from the customer and/or supplier systems(s) 210, including but not limited to accounts payable (A/P) invoice data, A/P payment files, A/P positive pay files, A/P direct debit files, accounts receivable (A/R) customer invoices, supplier master data, customer master data, intercompany invoices, purchase orders (PO's), sales orders (SO's), open A/P and A/R invoice or summary data, A/P payment files (e.g., ACH, PAIN.001.xml, or other formats), A/P controlled disbursement checks issued, and/or A/R direct debit files (e.g., PAIN.008.xml, BoE, or other formats), etc.

Accounting data sources 212 may include one or more external financial institutions, investment firms, accounting firms, or the like, storing data associated with the organization (including subsidiaries and/or parent companies). The data enrichment system 104 may retrieve various types of accounting, finance, and investment data from the accounting data sources 212, including but not limited to payments and direct debits (e.g., high-value wires, domestic ACH, international ACH, checks issues, payment status reports, card activity and balances due for the billing period, etc.). Additional accounting data from accounting data sources 212 may include account statements (e.g., end of day statements, current day statements, confirmations of debit/credit transactions, lockbox activity statements, end-of-month statements and account analysis, billing statements, investment account statements, paid checks reports, outstanding checks, returned items, etc. Further examples of the accounting data from accounting data sources 212 may include investment data (e.g., trade confirmations, daily transaction activities, end-of-day holdings and positions, etc.), as well as data representing the organization's derivatives, trade services, collateral management data, etc.

Currency exchanges 214 may include one or more external currency exchange entities or data sources. The data enrichment system 104 may retrieve various types of currency exchange data associated with the organization from the currency exchanges 214, including but not limited to foreign exchange (FX) trades, FX confirmations, end-of-day holdings, banking platforms and voice trades, etc.

Market data sources 216 may include one or more external systems configured to analyze and/or provide market data. The data enrichment system 104 may retrieve various market-related data from the market data sources 216, including but not limited to foreign exchange rates (e.g., spot rates, forward rates, fixing and benchmark rates, FX index rates, volatilities, etc.), interest rates (e.g., IR curves, commercial paper rates, benchmark bond rates, etc.), money market rates (e.g., daily dividend factor, attributes, expense ratio, floating NAV, daily fund holdings, etc.), commodity prices, counterparty risk data (e.g., credit default swap rates, tier 1 capital ratings, bond/equity values, etc.), equity rates (e.g., stock prices, indexes, etc.), credit ratings, entity financial and credit data, global banking holidays, and the like.

Tax data sources 218 may include one or more external systems configured to analyze and/or provide tax data associated with the organization. The data enrichment system 104 may retrieve various tax-related data from the tax data sources 218, including but not limited to project tax cash and payments.

Merchant data sources 220 may include one or more external systems operated by merchant entities, that may be configured to provide various merchant data for the organization. The data enrichment system 104 may retrieve merchant data from the merchant data sources 220, including but not limited to all transactions between the merchant and the organization, all settlements between the merchant and the organization, interchange analysis and/or billing data, etc.

As shown in this example, any or all of the data sources 202-220 may expose APIs to facilitate data retrieval and extraction by the data enrichment system 104. Additionally or alternatively, the cloud-based treasury system 102 may include the APIs 222 and APIs 224, which may be individually developed based on the separate data storage technologies, networks, data structures, and/or schemas implemented for the individual data sources 202-220. In some cases, the APIs 222 associated with internal data sources 202-210 may provide different connectivity, security, and authentication techniques than the APIs 224 associated with external data sources 212-220. In some cases, when extracting data from secure external systems, such as the accounting data sources 212, tax data sources 218, and/or merchant data sources 220, the cloud-based treasury system 102 may provide secure APIs. Double-layer APIs may be implemented in some examples, in which a first API layer (e.g., an API gateway) handles security and authentication with the external data source, and a second API layer implements the logic for transporting and storing the data.

As described above, the aggregated data received and processed by the data enrichment system 104 from data sources 202-220 (and various other sources of treasury/financial data for the organization) may represent a financial ecosystem for the organization. The data enrichment system 104 also may determine corresponding or related data fields received from the different data sources 202-220, and may create associations between the related data fields in the treasury data store(s) 112. For instance, a first data field received from one data source may refer to the same object (e.g., the same asset, account, transaction, entity, etc.) as a second data field received from another data source. The data enrichment system 104 may use rules and/or models to determine the data associations and integrate (or otherwise associate) the related data fields within treasury data store(s) 112, thereby allowing the analytics component 106 analytics to execute more robust and accurate tools and analytics on the holistic financial ecosystem of the organization.

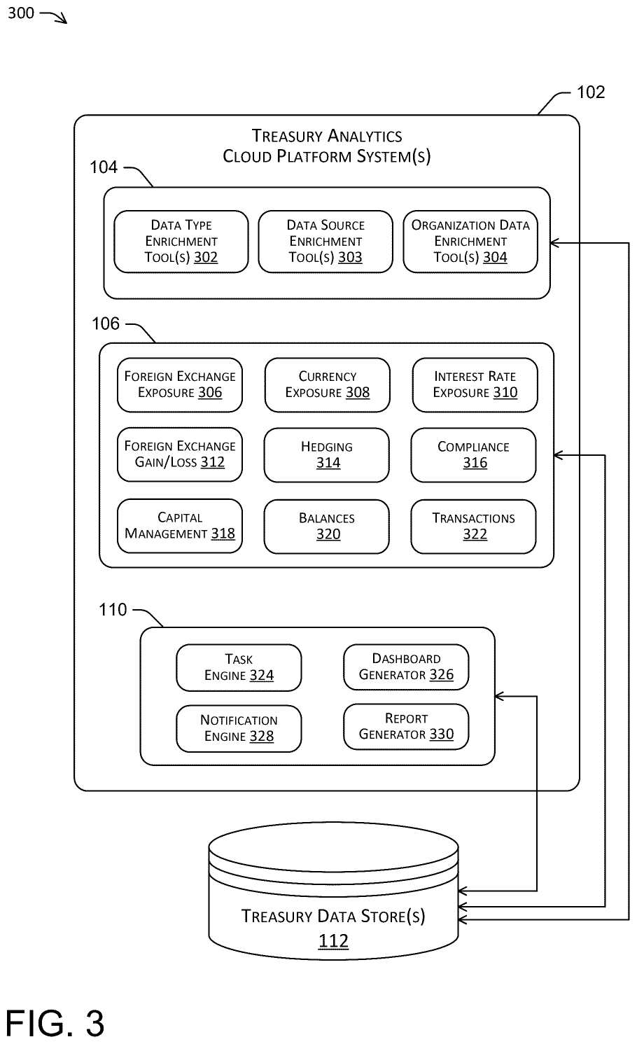

FIG. 3 shows an example computing environment 300 including a cloud-based treasury system 102 and a treasury data store(s) 112. The computing environment 300 may be similar or identical to the computing environment 100, and the cloud-based treasury system 102 and treasury data store(s) 112 may be similar or identical to the corresponding systems described above. However, in this example the cloud-based treasury system 102 is depicted in more detail, showing a number of components and subcomponents configured to perform specific functionality within the data enrichment component 104, analytics component 106, and the interface component 110. These example components and subcomponents describe additional possible features and functionalities that may be implemented in some examples. However, as noted above, it is understood that these additional features and functionalities are illustrative and need not be implemented in all cases. Further, the techniques described herein are not limited to these specific features and/or functionalities, or to finance/treasury systems in general, may be applied to other data integration systems, tools or analytics systems, and/or interface components used for organization management.

The data enrichment component 104 in this example includes tools 302-304 configured to analyze and enrich the data received from the various internal and external sources for treasury data. For instance, tools 302-304 may include rules engines and/or trained models configured to analyze the data inputs received from data sources 202-220. Using the rules/models, tools 302-304 may modify or restructure the treasury data received from the data sources 202-220. In some cases, the tools 302-304 may include rules and/or models to analyze data received from data sources (e.g., text descriptions, metadata, combinations of fields) and classify the data into a particular data type or associate the data with a particular data object (e.g., entity, account, transaction, currency, etc.). The tools 302-304 also may be configured to determine associations between the data items or objects received from different data sources, so that that data can be integrated or cross-referenced within the treasury data store(s) 112.

As shown in this example, the data enrichment component 104 includes one or more data type enrichment tool(s) 302, data source enrichment tool(s) 303, and/or organization data enrichment tool(s) 304. Each of the tools 302-304 may include similar or related rules and/or models for analyzing, transforming, and/or associated the data received from data sources 202-220. In this example, the data type enrichment tool(s) 302 may be executed for data of specific types, and not for other types. For instance, the data enrichment component 104 may determine and execute a first data type enrichment tool 302 for a first type of received data (e.g., A/P invoice data), and may determine and execute a second data type enrichment tool 302 for a second type of received data (e.g., merchant billing statements). Any number of type-specific data enrichments may be performed using the data type enrichment tool(s) 302, for any data type or combination of data types described herein.

Similarly, in this example the data source enrichment tool(s) 303 may be executed for data received from specific data sources, and not for data received from other data sources. As an example, the data enrichment component 104 may determine and execute a first data source enrichment tool 303 on a balance statement received from an internal accounting system 202, and may determine and execute a different second data source enrichment tool 303 on a balance statement (e.g., the same or a different balance statement) received from an internal customer/supplier system 210 or from an external accounting data source 212, etc. Any number of data source-specific data enrichments may be performed using the data source enrichment tool(s) 303, for any data source or combination of data sources described herein.

Additionally or alternatively, this example includes organization data enrichment tool(s) 304, that may be executed for data associated with specific organizations and not for data associated with other organizations. As an example, the data enrichment component 104 may determine and execute a first organization data enrichment tool 304 on a tax record associated with a first subsidiary or partner of the organization, and may determine and execute a second organization data enrichment tool 304 on a tax record associated with a second subsidiary or partner of the organization. Any number of organization-specific data enrichments may be performed using the organization data enrichment tool(s) 304, for any organization or combination of organizations described herein.

Within the analytics component 106, this example depicts a number of data analytics and/or BI tools, that may be executed by the cloud-based treasury system 102 to perform various risk analyses and other organization management tasks. Each of the components 306-322 may include one or more software applications implemented as data analytics and/or BI tools. In various examples, the components 306-322 may execute heuristics-based algorithms and/or trained machine-learned models, to perform treasury-related analyses of the organization's data within the treasury data store(s) 112. General examples of data analytics and BI tools may include reporting/dashboarding tools, analytical processing (e.g., OLAP) tools, data mining and monitoring, etc.

In this example, the foreign exchange exposure component 306 may be a software executable configured to use heuristics and/or trained models to determine one or more risk metric(s) based on the organization's exposure to possible changes in foreign exchange rates. The currency exposure component 308 may be configured to determine one or more risk metric(s) based on the organization's currency exposure for one or more currencies. The interest rate exposure component 310 may be configured to determine one or more risk metric(s) based on the organization's exposure to possible interest rate changes. The foreign exchange gain/loss component 312 may be configured to calculate (and/or predict) gain/loss risk metrics for the organization based on foreign exchange activities. The hedging component 314 may be configured to calculate an optimal hedging position for the organization. The compliance component 316 may be configured to determine the organization's level of compliance with various internal and external rules, and policies. The capital management component 318 may be configured to determine an optimal capital management strategy for the organization. The balances component 320 may be configured to determine and summarize the current balances for the organization across the entire financial ecosystem of the organization. The transactions component 332 may be configured to determine and summarize the current state of the transactions across the entire financial ecosystem of the organization.

Each of the components 306-322 in these examples may be executed using input data associated with the organization, which may include any combination of enriched data retrieved from the treasury data store(s) 112. In various examples, any or all of the analytics/tools components 306-322 may be executed based on a current snapshot and/or a recent time period of the treasury data for the organization. In other examples, the analytics/tools components 306-322 may be executed using historical data retrieved from the treasury data store(s) 112, to perform historical and/or comparative analyses for the organization.

Additionally, in this example, the interface component 110 includes a number of components associated with different data output techniques. In various implementations, the cloud-based treasury system 102 may support any combination of the output components described herein. For example, task engine 324 may be implemented to generate tasks to be performed automatically based on the outputs of the analytics/tools components 306-322. In some cases, the task engine 324 may be configured to automatically generate a task based on a risk exposure threshold or any other output criteria associated with the analytics component 106. The task engine 324 also may be configured to automatically assign the task to an individual, group, or entity within the organization, and to monitor and track to task (e.g., verifying completion, closing, reassigning, etc.).

In this example, the interface component 110 also includes a dashboard generator 326, notification engine 328, and report generator 330. The dashboard generator 326 may be configured to generate and output an interactive dashboard to include data output by the analytics/tools components 306-322, and/or may include user interface components configured based on the outputs of the analytics/tools components 306-322. The notification engine may include functionality to allow users (via client devices 122) or automated downstream systems 124 to register for and receive notifications based on data output by the analytics/tools components 306-322. In some examples, the dashboard generator 326, notification engine 328, and/or report generator 330 may be configured to generate and output different customized interfaces for different organizations (e.g., subsidiaries), different users, and/or different thresholds for the outputs of data analytics/tools.

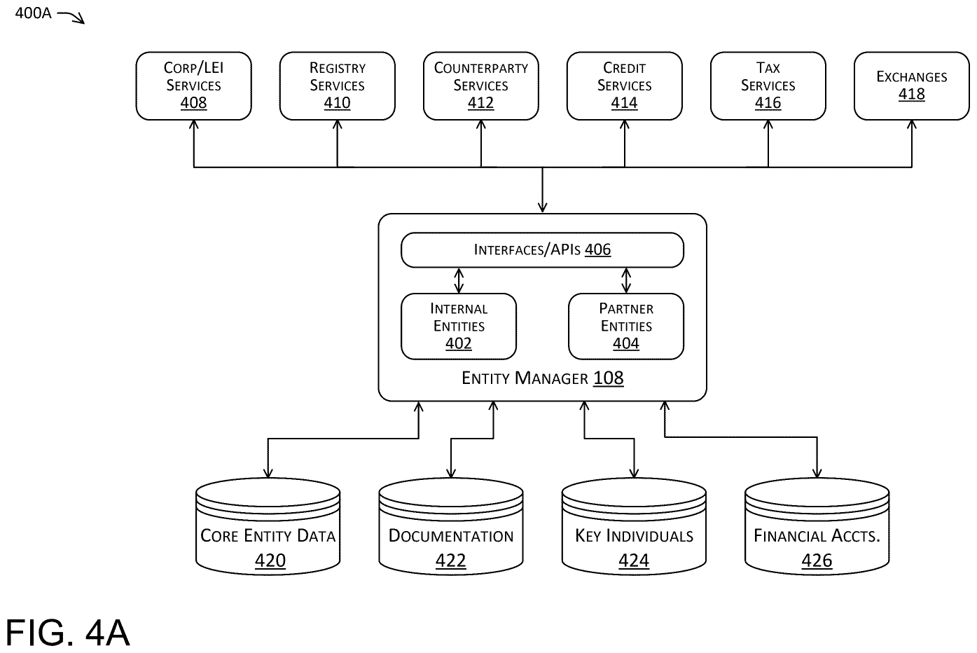

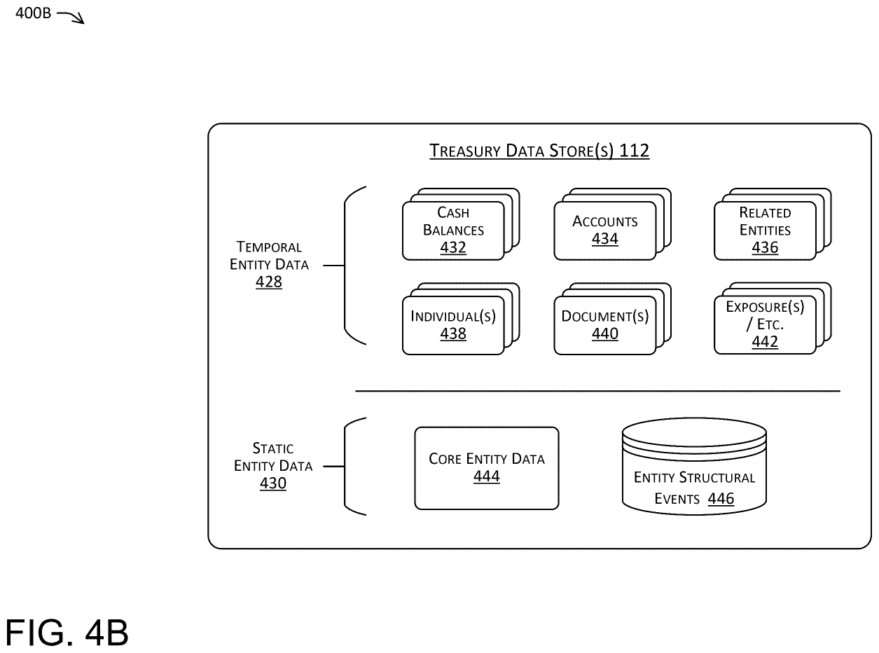

FIG. 4A shows an example computing environment 400A, including an entity manager 108 associated with the organization. As shown in this example, the entity manager 108 may be configured to collect, store, and manage entity data for the relevant entities associated with the treasury system of the organization. As used herein, an entity may refer to an individual, a set of individuals, a business organization/department, and/or a legal entity. Internal entities 402 may include data representing the entities internal to the organization, such as the individuals (e.g., employees, officers, investors, etc.), departments, subsidiaries, and related entities. In contrast, partner entities 404 may include similar or identical types of data representing the relevant entities external to the organization, such as the individuals, departments, corporations, and subsidiaries for partner entity. A partner entity may be an external company or other entity associated with the organization, such as a customer, supplier, merchant, bank, accounting firm, investing firm, etc.

As shown in this example, the entity manager 108 may include an interface and/or API layer 406 configured to retrieve entity data from various entity data sources 408-418. The entity manager 108 may send requests via the interface and/or API layer 406 to receive data from the entity data sources 408-418. The entity manager 108 then may organize the received entity data into categories to be stored in separate storage locations. In this example, the entity manager 108 may receive entity data from one or more corporate and/or legal entity identifier (LEI) services 408, registry services 410, counterparty services 412, credit services 414, tax services 416, and/or exchanges 418. Entity data received from any or all of the data sources 408-418 may be organized by the entity manager 108 into categories by data type and/or entity type. The entity manager 108 then may store the entity data into separate data structures and/or data stores 420, based on the data categories/types. In this example, the entity manager 108 may classify and store the entity data into separate data stores, respectively structured and configured into a core entity data store 420 (e.g., storing addressing, tax identifiers and numbers, registrations, business profiles, compliance, etc.), documentation data store 422 (e.g., storing articles of incorporation, bylaws, banking resolutions, certificates of incumbency, etc.), a key individuals data store 424 (e.g., storing officer and director data, key control person data, bank account signer data, authorized trader data, payment approver data, etc.), and a financial accounts data store 426 (e.g., storing bank accounts owned by internal entity, accounts held with a banking partner, account attributes including signers, etc.). As this example shows, retrieving and separating entity data into separate data structures or data stores 420-426 within the treasury data store(s) 112 allows the system to execute more advanced and robust data analytics and BI tools, because the entity data can be segregated, sorted, and quickly analyzed based on data type category rather than based on the entity or the data source.

As shown in this example, the entity manager 108 may receive data from any number of data sources representing both legal entity data and financial (e.g., banking) data. Based on the various received legal entity data and financial data, entity manager 108 may determine associations between the legal entities and financial data, including temporal associates, and may store the various data within one or more data stores as described herein. In some examples, based on the data determined and stored by the entity manager 108, the entity manager 108 may operate as a system of record for the combination of the legal entity and/or financial data for an entity or set of related entities. As a system of record, the legal entity data, financial data, and/or the data storing associations between the legal entities and financial data (e.g., accounts, balances, transfers, etc.) may constitute the master copy of any or all of this data, which may be provided to any number of downstream services or applications.

Additionally, as noted above, the entity manager 108 may receive counterparty data from one or more counterparty services 412. In some examples, the entity manager 108 may be configured to generate and/or store a master copy of the counterparty data associated with one or more financial institutions. The master counterparty data may include data identifying the parent company (e.g., a bank) along with the accurate listing of each of the related subsidiaries of the parent company, including the countries for each subsidiary, the master listing of codes to be used for payments to/from each subsidiary, the attributes and/or data sets for each subsidiary, etc. In these examples, the master counterparty data may function as mappings between different internal counterparty services 412 associated with a single parent company.

FIG. 4B depicts an example data storage architecture 400B for one or more treasury data store(s) 112. Similar or identical storage systems to those depicted in storage architecture 400B may be used in any of the implementations described herein. As discussed above in reference to FIG. 4A, the treasury data store(s) 112 may be created and managed at least in part by an entity manager 108. The data storage architecture 400B may be configured to store, manage, and track data, including both static and dynamic entity-related data, that is similar or identical to the data stored in data stores 420-426 and/or additional data stores based on entity-related data received from any data sources 202-220.

In this example, the data storage architecture 400B depicts a number of different databases (or data stores) storing different types of entity-related data. The data stores include a cash balances data store 432, an accounts data store 434, a related entities data store 436, a related individuals data store 438, a documentation data store 440, and an exposure data store 442. The combination of data stores 432-442 can store any types of data relating to a legal entity (or related network of entities), including data relating to the legal/corporate entity itself and/or relevant events (e.g., registration tracking, ownership, bank accounts, signatories, officers and directors, renewals, document management, etc.), as well as entity-related accounting data, tax data, financial institution and account data, employee data, transaction data, exposure risk data, domestic and/or foreign currency data, etc. In this example, each of the data stores 432-442 may store temporal entity data 428 related to one particular entity and/or networks of related entities, over time periods during which the entities may evolve and the associated entity-related data may change. Although only a few examples of temporal entity data 428 are shown herein for illustrative purposes, in other examples, data stores may be included for any other type of entity-related data.

Each data store 432-442 shown in the data storage architecture 400B, and/or other types of data stores used in other examples, may be implemented using various data storage technologies. For instance, data stores 432-442 may be implemented as tables, files, or databases, or other storage structures that reside within the same database/data store, or that are implemented within separate databases/data stores. In some cases, the different data stores 432-442 can be on different servers, different clouds, different networks, and/or within different data centers. For example, legal entity/corporate data relating to an entity may reside within a first data store stored securely within a first company data center, while cash balance data for the entity may be stored in a separate cloud-based data store, and accounts data may be stored in a separate cloud and/or in a third-party data system associated with a financial institution, and so on.

As shown in this example, the data storage architecture 400B used by the treasury data store(s) 112 may be configured to store certain types of entity-related data as temporal entity data 428, and other types of data as static entity data 430. Temporal entity data may include any entity data that is tracked over a period of time during which the data may be changed. The data stores of the temporal entity data 428 may be stored using temporal databases, time-coded tables or files, etc., and each of the data stores 432-442 may include multiple snapshots of their respective entity data corresponding to different time periods or different events during the life of the entity. For instance, cash balance data store 434 may be stored as tables including a daily cash balance snapshot for each entity in a network of related entities, the individual data store 438 may store a weekly snapshot of employee data, the accounts data store 434 may store a snapshot of certain accounting data for every quarter that the entity is in existence, and so on.

Additionally or alternatively, the temporal entity data 428 may store different versions (e.g., snapshots) of their entity-related data, in which each version is associated with a structural event of the entity (or the time period between two adjacent structural events). For instance, structural entity events such as the creation of a new legal entity, dissolution of an existing legal entity, restructuring or reorganizing relationships between entities, mergers, acquisitions, etc., may cause a new snapshot of an entity to be generated within the related entities data store 436, and/or a new version of legal entity documentation within the data store 440. In these examples, the data versions/snapshots of the temporal entity data need not be updated based on time, but may reflect the current and accurate data snapshot until a subsequent structural entity event occurs that affects the same entity (e.g., regardless of the amount of time that passes between structural entity event).

In contrast to the temporal entity data 428, wherein multiple versions/snapshots of the changing data may be captured, retained, and tracked, the static entity data 430 may include data stores/databases of unchanging data and/or data for which temporal data snapshots are not needed. For example, the core entity data store 444 may store unchanging entity/corporate data such as entity creation data, founding dates and charters, dissolution dates, etc. The static entity data 430 may store any other unchanging data associated with entities, individuals, accounts, counterparty institutions, etc. For instance, an individual(s) data store within the static entity data 430 may store unchanging individual information, such as social security numbers, birth dates, employment start/end dates, etc. Additionally, the static entity data 430 may store a database of chronologically ordered entity structural events for any combination of the entities having entity-related data in the temporal entity data 428. The storage of such data as static entity data 430 may provide advantages both for storage efficiency (e.g., so that redundant copies of the same unchanging data are not retained by the data store(s) 112), and for data security (e.g., to reduce or eliminate data replication, backup, and archiving of confidential or sensitive data over various networks and in various data storage systems from which a data breach may potentially occur).

As discussed below, in certain techniques described herein, user interfaces and/or other interface types (e.g., APIs, file transfer protocols, etc.) may be implemented to provide and/or manage entity data in such a way as to provide data periodicity. In such examples, various types of entity-related data (e.g., legal/corporate data, accounting or financial data, tax data, currency balance data, employee data, transaction data, exposure risk data, etc.) may be aggregated for an entity for a particular previous time during the life of the entity. For instance, a snapshot of the legal/corporate structure of an entity may be determined for a previous historical time of an entity, and various dimensions of temporally stored treasury data may be retrieved for the previous time and aggregated with (e.g., overlaid onto) a snapshot of the legal/corporate structure at the previous time. These techniques may include initially determining a set of entities related to a primary entity at a particular previous time, and the legal/corporate structure of the related-entities to the primary entity at the particular time, and then determining additional entity-related treasury data for the primary entity and the additional related entities at the previous time. In various examples, a user or client process may request a snapshot view of a particular entity for any time between the initial creation of the entity and the current time, and the entity manager may retrieve the set and structure of additional entities related to the requested entity at the requested time, and any additional treasury-related data to be overlaid on (or otherwise presented with) the entity legal/corporate data for the requested time. Additionally, such views may be altered on-the-fly and a different time may be requested for the primary entity. In response to the time updates, the entity manager 108 may retrieve the updated set and structure of entities for the new time, after which the updated data may be retrieved for the new set of entities, and the updated view may be rendered. In some examples, such time-based updates may include querying the temporal entity data 428 to retrieve the updated treasury data for the entities, but need not include querying the static entity data 430.

As describe above, the entity manager 108 may be configured to support periodicity by capturing and storing snapshots of the relevant legal entity data and/or financial data corresponding to different points in time within the life of an entity. The data may be stored with temporal databases, time-coded tables or files, and the like each of which may store multiple time-based snapshots of entity-related data. In various examples, the entity manager 108 may use a combination of manual and/or automated techniques for determining which entity-related data fields should be included in each data snapshot, how often and at what frequency each data snapshot is captured (e.g., periodically or in response to an entity event such as a merger or acquisition), and/or how to perform the close process for capturing the entity-related data for the snapshot. The entity manager 108 may perform each of these determinations for capturing legal entity data snapshots based on heuristics and/or trained machine-learned (ML) models configured to output legal entity snapshot data fields, snapshot times, etc., based on the various legal entity input data sources described herein.

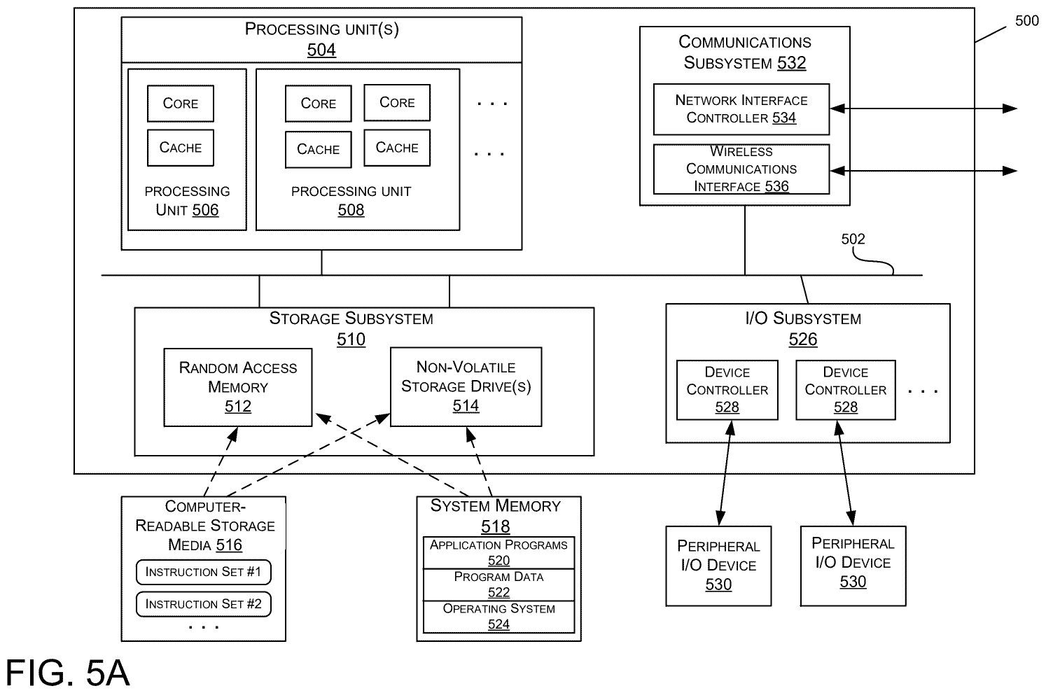

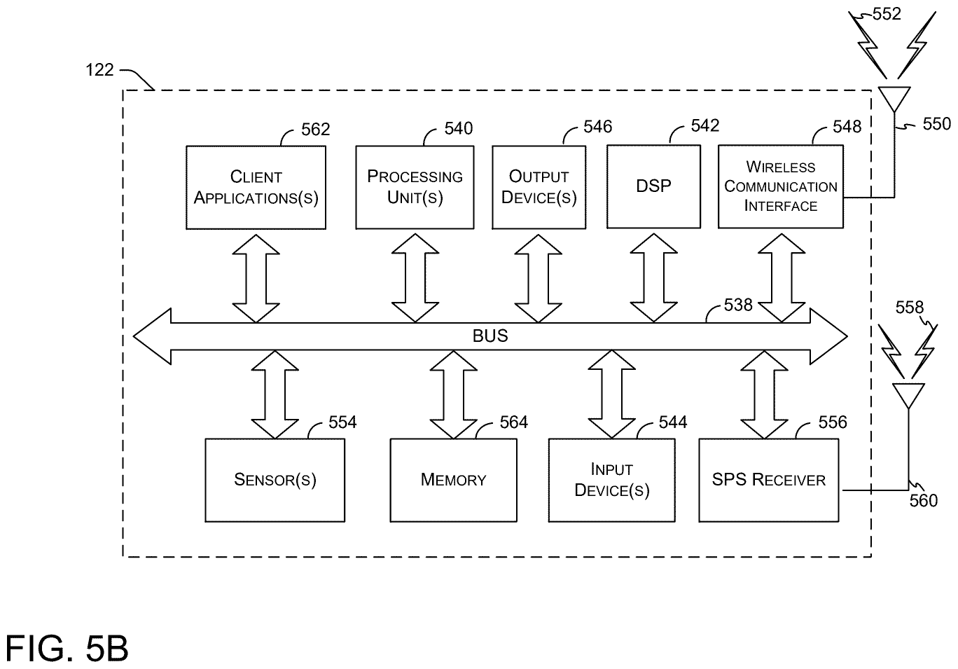

FIG. 5A shows a block diagram of an example computer system 500. The system 500 may correspond to any of the computing devices or servers of the computing environment 100 described above, any components subcomponents thereof, or any other computing devices described herein. In this example, computer system 500 includes processing units 504 that communicate with a number of peripheral subsystems via a bus subsystem 502. These may peripheral subsystems include, for example, a storage subsystem 510 (or memory 510), an I/O subsystem 526, and a communications subsystem 532.

Bus subsystem 502 provides a mechanism for letting the various components and subsystems of computer system 500 communicate with each other as intended. Although bus subsystem 502 is shown schematically as a single bus, in alternative examples the bus subsystem may utilize multiple buses. Bus subsystem 502 may be any of several types of bus structures including a memory bus or memory controller, a peripheral bus, and a local bus using any of a variety of bus architectures. Such architectures may include, for example, an Industry Standard Architecture (ISA) bus, Micro Channel Architecture (MCA) bus, Enhanced ISA (EISA) bus, Video Electronics Standards Association (VESA) local bus, and Peripheral Component Interconnect (PCI) bus, which can be implemented as a Mezzanine bus manufactured to the IEEE P1386.1 standard.

Processing unit 504, which may be implemented as one or more integrated circuits (e.g., a conventional microprocessor or microcontroller), controls the operation of computer system 500. One or more processors, including single core and/or multicore processors, may be included in processing unit 504. As shown in this example, processing unit 504 may be implemented as one or more independent processing units 506 and/or 508 with single or multicore processors and processor caches included in each processing unit. Processing unit 504 may also be implemented as a quad-core processing unit or larger multicore designs (e.g., hexa-core processors, octo-core processors, ten-core processors, or greater. As discussed above, in some cases, processing unit 504 may include one or more specialized ASICs designed and configured for specialized cryptographic hardware for handling cryptocurrency transactions.

Processing unit 504 may execute a variety of software processes embodied in program code, and may maintain multiple concurrently executing programs or processes. At any given time, some or all of the program code to be executed can be resident in processor(s) 504 and/or in storage subsystem 510. In some examples, computer system 500 may include one or more specialized processors, such as digital signal processors (DSPs), outboard processors, graphics processors, application-specific processors, and/or the like.

I/O subsystem 526 may include device controllers 528 for one or more user interface input devices and/or user interface output devices 530. User interface input and output devices 530 may be integral with the computer system 500 (e.g., integrated audio/video systems, and/or touchscreen displays), or may be separate peripheral devices which are attachable/detachable from the computer system 500.

Input devices 530 may include a keyboard, pointing devices such as a mouse or trackball, a touchpad or touch screen incorporated into a display, a scroll wheel, a click wheel, a dial, a button, a switch, a keypad, audio input devices with voice command recognition systems, microphones, and other types of input devices. Input devices 530 may also include three dimensional (3D) mice, joysticks or pointing sticks, gamepads and graphic tablets, and audio/visual devices such as speakers, digital cameras, digital camcorders, portable media players, webcams, image scanners, fingerprint scanners, barcode reader 3D scanners, 3D printers, laser rangefinders, and eye gaze tracking devices. Additional input devices 550 may include, for example, motion sensing and/or gesture recognition devices that enable users to control and interact with an input device through a natural user interface using gestures and spoken commands, eye gesture recognition devices that detect eye activity from users and transform the eye gestures as input into an input device, voice recognition sensing devices that enable users to interact with voice recognition systems through voice commands, medical imaging input devices, MIDI keyboards, digital musical instruments, and the like.

Output devices 530 may include one or more display subsystems, indicator lights, or non-visual displays such as audio output devices, etc. Display subsystems may include, for example, cathode ray tube (CRT) displays, flat-panel devices, such as those using a liquid crystal display (LCD) or plasma display, light-emitting diode (LED) displays, projection devices, touch screens, and the like. In general, use of the term “output device” is intended to include all possible types of devices and mechanisms for outputting information from computer system 500 to a user or other computer. For example, output devices 530 may include, without limitation, a variety of display devices that visually convey text, graphics and audio/video information such as monitors, printers, speakers, headphones, automotive navigation systems, plotters, voice output devices, and modems.

Computer system 500 may comprise one or more storage subsystems 510, comprising hardware and software components used for storing data and program instructions, such as system memory 518 and computer-readable storage media 516. The system memory 518 and/or computer-readable storage media 516 may store program instructions that are loadable and executable on processing units 504, as well as data generated during the execution of these programs.

Depending on the configuration and type of computer system 500, system memory 518 may be stored in volatile memory (such as random-access memory (RAM) 512) and/or in non-volatile storage drives 514 (such as read-only memory (ROM), flash memory, etc.) The RAM 512 may contain data and/or program modules that are immediately accessible to and/or presently being operated and executed by processing units 504. In some implementations, system memory 518 may include multiple different types of memory, such as static random-access memory (SRAM) or dynamic random-access memory (DRAM). In some implementations, a basic input/output system (BIOS), containing the basic routines that help to transfer information between elements within computer system 500, such as during start-up, may typically be stored in the non-volatile storage drives 514. By way of example, and not limitation, system memory 518 may include application programs 520, such as client applications, Web browsers, mid-tier applications, server applications, etc., program data 522, and an operating system 524.

Storage subsystem 510 also may provide one or more tangible computer-readable storage media 516 for storing the basic programming and data constructs that provide the functionality described in the various examples herein. Software (programs, code modules, instructions) that when executed by a processor provide the functionality described herein may be stored in storage subsystem 510. These software modules or instructions may be executed by processing units 504. Storage subsystem 510 may also provide a repository for storing data used in accordance with certain examples.

Storage subsystem 510 may also include a computer-readable storage media reader that can further be connected to computer-readable storage media 516. Together and, optionally, in combination with system memory 518, computer-readable storage media 516 may comprehensively represent remote, local, fixed, and/or removable storage devices plus storage media for temporarily and/or more permanently containing, storing, transmitting, and retrieving computer-readable information.

Computer-readable storage media 516 containing program code, or portions of program code, may include any appropriate media known or used in the art, including storage media and communication media, such as but not limited to, volatile and non-volatile, removable and non-removable media implemented in any method or technology for storage and/or transmission of information. This can include tangible computer-readable storage media such as RAM, ROM, electronically erasable programmable ROM (EEPROM), flash memory or other memory technology, CD-ROM, digital versatile disk (DVD), or other optical storage, magnetic cassettes, magnetic tape, magnetic disk storage or other magnetic storage devices, or other tangible computer readable media. This can also include nontangible computer-readable media, such as data signals, data transmissions, or any other medium which can be used to transmit the desired information and which can be accessed by computer system 500.

By way of example, computer-readable storage media 516 may include a hard disk drive that reads from or writes to non-removable, nonvolatile magnetic media, a magnetic disk drive that reads from or writes to a removable, nonvolatile magnetic disk, and an optical disk drive that reads from or writes to a removable, nonvolatile optical disk such as a CD ROM, DVD, and Blu-Ray® disk, or other optical media. Computer-readable storage media 516 may include, but is not limited to, Zip® drives, flash memory cards, universal serial bus (USB) flash drives, secure digital (SD) cards, DVD disks, digital video tape, and the like. Computer-readable storage media 516 may also include, solid-state drives (SSD) based on non-volatile memory such as flash-memory based SSDs, enterprise flash drives, solid state ROM, and the like, SSDs based on volatile memory such as solid state RAM, dynamic RAM, static RAM, DRAM-based SSDs, magnetoresistive RAM (MRAM) SSDs, and hybrid SSDs that use a combination of DRAM and flash memory based SSDs. The disk drives and their associated computer-readable media may provide non-volatile storage of computer-readable instructions, data structures, program modules, and other data for computer system 500.

Communications subsystem 532 may provide a communication interface from computer system 500 and external computing devices via one or more communication networks, including local area networks (LANs), wide area networks (WANs) (e.g., the Internet), and various wireless telecommunications networks. As illustrated in FIG. 5A, the communications subsystem 532 may include, for example, one or more network interface controllers (NICs) 534, such as Ethernet cards, Asynchronous Transfer Mode NICs, Token Ring NICs, and the like, as well as one or more wireless communications interfaces 536, such as wireless network interface controllers (WNICs), wireless network adapters, and the like. Additionally and/or alternatively, the communications subsystem 532 may include one or more modems (telephone, satellite, cable, ISDN), synchronous or asynchronous digital subscriber line (DSL) units, FireWire® interfaces, USB® interfaces, and the like. Communications subsystem 536 also may include radio frequency (RF) transceiver components for accessing wireless voice and/or data networks (e.g., using cellular telephone technology, advanced data network technology, such as 3G, 4G or EDGE (enhanced data rates for global evolution), WiFi (IEEE 802.11 family standards, or other mobile communication technologies, or any combination thereof), global positioning system (GPS) receiver components, and/or other components.

The various physical components of the communications subsystem 532 may be detachable components coupled to the computer system 500 via a computer network, a FireWire® bus, or the like, and/or may be physically integrated onto a motherboard of the computer system 500. Communications subsystem 532 also may be implemented in whole or in part by software.

In some examples, communications subsystem 532 may also receive input communication in the form of structured and/or unstructured data feeds, event streams, event updates, and the like, on behalf of one or more users who may use or access computer system 500. For example, communications subsystem 532 may be configured to receive data feeds in real-time from users of social networks and/or other communication services, web feeds such as Rich Site Summary (RSS) feeds, and/or real-time updates from one or more third-party information sources. Additionally, communications subsystem 532 may be configured to receive data in the form of continuous data streams, which may include event streams of real-time events and/or event updates (e.g., sensor data applications, financial tickers, network performance measuring tools, clickstream analysis tools, etc.). Communications subsystem 532 may output such structured and/or unstructured data feeds, event streams, event updates, and the like to one or more data stores that may be in communication with one or more streaming data source computers coupled to computer system 500.

Due to the ever-changing nature of computers and networks, the description of computer system 500 depicted in FIG. 5A is intended only as a specific example. Many other configurations having more or fewer components than computer system 500 are possible. For example, customized hardware might also be used and/or particular elements might be implemented in hardware, firmware, software, or a combination. Further, connection to other computing devices, such as network input/output devices, may be employed. Based on the disclosure and teachings provided herein, a person of ordinary skill in the art will appreciate other systems and/or methods for implementing the various techniques.

Referring now to FIG. 5B, a block diagram is shown illustrating the component of an example client device 122, for example, a smartphone, tablet computer, other mobile device, or an Internet-of-Things (IoT) device, which may be utilized as described in the examples herein. It should be noted that FIG. 5B is meant to provide only a general illustration of various components, any or all of which may be utilized as appropriate. As discussed above, client devices 122 may include, for example, mobile devices such as smartphones and tablet computers, as well as other various types of user computing devices (e.g., personal computers, laptops, home monitoring/security display devices, weather station displays, digital picture frames, smart watches, wearable computing devices, and/or vehicle-based display devices). Client devices 122 corresponding to IoT devices, sensor devices, and/or other electronic appliances may include, for example, security systems, intruder and fire alarm systems, utility meters (e.g., for gas, water, electrical, etc.), weather sensors, facility management services, vehicle-based systems, personal appliances/health monitoring devices, industrial appliances and systems (e.g., PLC devices), personal electronic appliances, person or animal tracking devices, lighting systems or speaking systems in public or commercial environments, or governmental infrastructure devices (e.g., street lamps, traffic lights, trash bins, etc.). Because client devices 122 may vary widely in functionality, any particular client device may include only a subset of the components shown in FIG. 5B. Additionally, in some cases, components illustrated in FIG. 5B may be localized to a single physical device and/or distributed among various networked devices, which may be disposed at different physical locations.

The client device 122 is shown in FIG. 5B comprising hardware elements that can be electrically coupled via a bus 538 (or may otherwise be in communication, as appropriate). The hardware elements may include a processing unit(s) 540 which may comprise without limitation one or more general-purpose processors, one or more special-purpose processors (such as digital signal processing (DSP) chips, graphics acceleration processors, application-specific integrated circuits (ASICs), and/or the like), and/or other processing structure or means, which can be configured to perform one or more of the methods described herein. As shown in FIG. 5B, the client device 122 may have a separate DSP 542, depending on desired functionality. The client device 122 also may comprise one or more I/O subsystems, including input devices 544 such as touch screens, touch pads, microphones, buttons, dials, switches, and/or the like; and output devices 546 such as one or more displays, light-emitting diode (LED) s, speakers, and/or the like.

Mobile client devices 122 may also include a wireless communication interface 548, which may comprise without limitation a modem, a network card, an infrared communication device, a wireless communication device, and/or a chipset (such as a Bluetooth® device, an IEEE 802.11 device, an IEEE 802.15.4 device, a Wi-Fi device, a WiMax device, cellular communication facilities, etc.), and/or the like, which may enable the mobile device 122 to communicate via the networks and RATs described above with regard to FIGS. 1-4. The wireless communication interface 548 may permit data to be communicated with a network, wireless access points, wireless base stations, other computer systems, and/or any other electronic devices described herein. The communication can be carried out via one or more wireless communication antenna(s) 550 that send and/or receive wireless signals 552.

Depending on desired functionality, the wireless communication interface 548 may comprise separate transceivers to communicate with base stations (e.g., eNBs) and other terrestrial transceivers, such as wireless devices and access points, belonging to or associated with one or more wireless networks. These wireless networks may comprise various network types. For example, a WWAN may be a CDMA network, a Time Division Multiple Access (TDMA) network, a Frequency Division Multiple Access (FDMA) network, an Orthogonal Frequency Division Multiple Access (OFDMA) network, a Single-Carrier Frequency Division Multiple Access (SC-FDMA) network, a WiMax (IEEE 802.16) network, and so on. A CDMA network may implement one or more radio access technologies (RATs) such as cdma2000, Wideband CDMA (WCDMA), and so on. Cdma2000 includes IS-95, IS-2000, and/or IS-856 standards. A TDMA network may implement GSM, Digital Advanced Mobile Phone System (D-AMPS), or some other RAT. An OFDMA network may employ LTE, LTE Advanced, NR and so on. LTE, LTE Advanced, NR, GSM, and WCDMA are described (or being described) in documents from 3GPP. Cdma2000 is described in documents from a consortium named “3rd Generation Partnership Project 2” (3GPP2). 3GPP and 3GPP2 documents are publicly available. A WLAN may also be an IEEE 802.11x network, and a WPAN may be a Bluetooth network, an IEEE 802.15x, or some other type of network. The techniques described herein may also be used for any combination of WWAN, WLAN and/or WPAN.

The client device 122 may further include sensor(s) 554. Such sensors may comprise, without limitation, one or more accelerometer(s), gyroscope(s), camera(s), magnetometer(s), altimeter(s), microphone(s), proximity sensor(s), light sensor(s), and the like. Some or all of the sensors 554 can be utilized, among other things, for sensing/detecting location data (e.g., sights, sounds, smells, substances, temperatures, etc.) at the location of the client device 122, or for obtaining operational status of an appliance or electrical device, and/or obtaining other types of data that may be communicated to an application server.

In some examples, client devices 120 may also include an SPS receiver 556 capable of receiving signals 558 from one or more SPS satellites using an SPS antenna 560, which may be combined with antenna(s) 550. Positioning of client devices 122 using SPS receivers 556 may be utilized to complement and/or incorporate the techniques described herein, and may be used to obtain sensor data by the client device 122. The SPS receiver 556 may support measurement of signals from SPS SVs of an SPS system, such as a GNSS (e.g., Global Positioning System (GPS)), Galileo, GLONASS, Quasi-Zenith Satellite System (QZSS) over Japan, Indian Regional Navigational Satellite System (IRNSS) over India, Beidou over China, and/or the like. Moreover, the SPS receiver 556 may be used with various augmentation systems (e.g., a Satellite Based Augmentation System (SBAS)) that may be associated with or otherwise enabled for use with one or more global and/or regional navigation satellite systems. By way of example but not limitation, an SBAS may include an augmentation system(s) that provides integrity information, differential corrections, etc., such as, e.g., Wide Area Augmentation System (WAAS), European Geostationary Navigation Overlay Service (EGNOS), Multi-functional Satellite Augmentation System (MSAS), GPS Aided Geo Augmented Navigation or GPS and Geo Augmented Navigation system (GAGAN), and/or the like. Thus, as used herein an SPS may include any combination of one or more global and/or regional navigation satellite systems and/or augmentation systems, and SPS signals may include SPS, SPS-like, and/or other signals associated with such one or more SPS.

Additionally, the client device 122 may include one or more client applications 562. Client applications 562 may include one or more executable software components configured to store and execute any combination of the client-side functionalities described herein. For instance, client applications 562 may include, by way of example, dashboard applications configured to present the risks of treasury simulate analytics, notification or alert applications, task/recommendation applications, report applications, etc.

The client device 122 may further include and/or be in communication with a memory 564. The memory 564 may comprise, without limitation, local and/or network accessible storage, a disk drive, a drive array, an optical storage device, a solid-state storage device, such as a random access memory (“RAM”), and/or a read-only memory (“ROM”), which can be programmable, flash-updateable, and/or the like. Such storage devices may be configured to implement any appropriate data stores, including without limitation, various file systems, database structures, and/or the like. The memory 564 may be used, among other things, to store sensor data received from sensors 554 using a database, linked list, or any other type of data structure. Wireless communication interface 548 may additionally or alternatively comprise memory.

The memory 564 of client device 122 also may comprise software elements (not shown), including an operating system, device drivers, executable libraries, and/or other code, such as one or more application programs, which may comprise computer programs described in the various examples herein, and/or may be designed to implement methods, and/or configure systems, provided by other examples, as described herein. Merely by way of example, one or more procedures described with respect to the functionality for client device 122 discussed above might be implemented as code and/or instructions executable by client device 122 (and/or a processing unit within the client device 122). Such code and/or instructions may be used to configure and/or adapt a general-purpose computer (or other device) to perform one or more operations in accordance with the described methods.

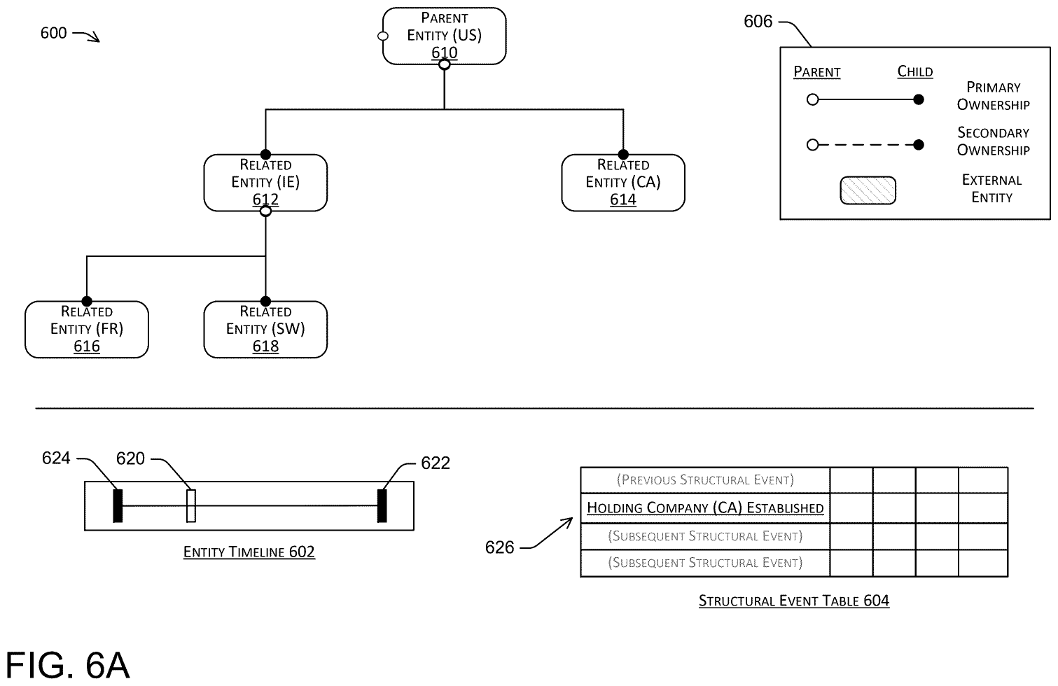

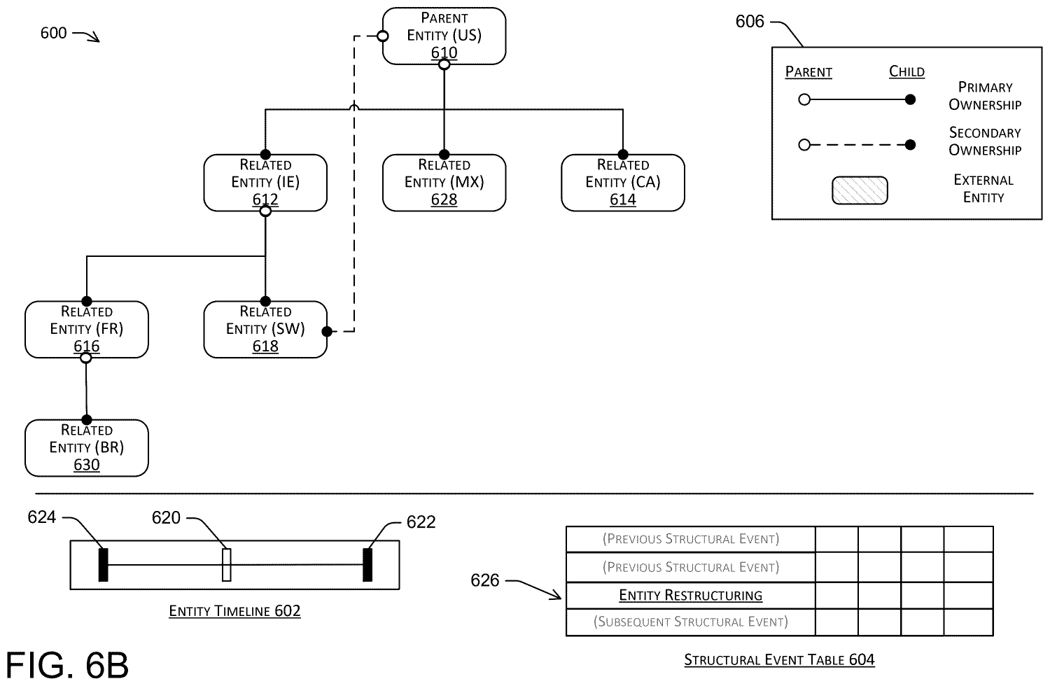

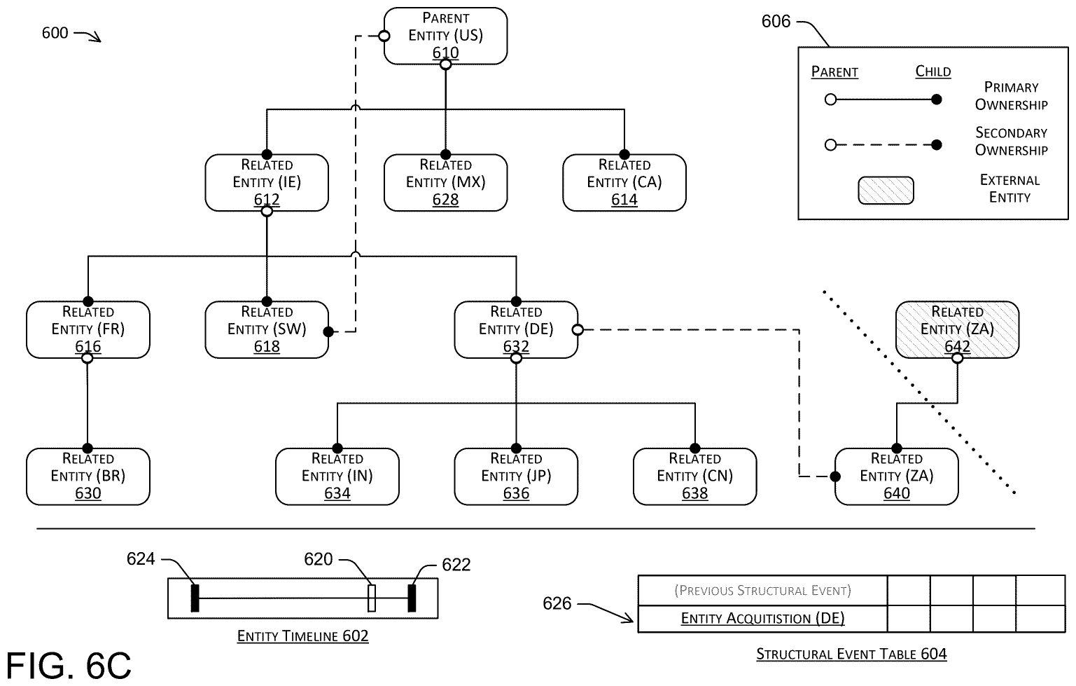

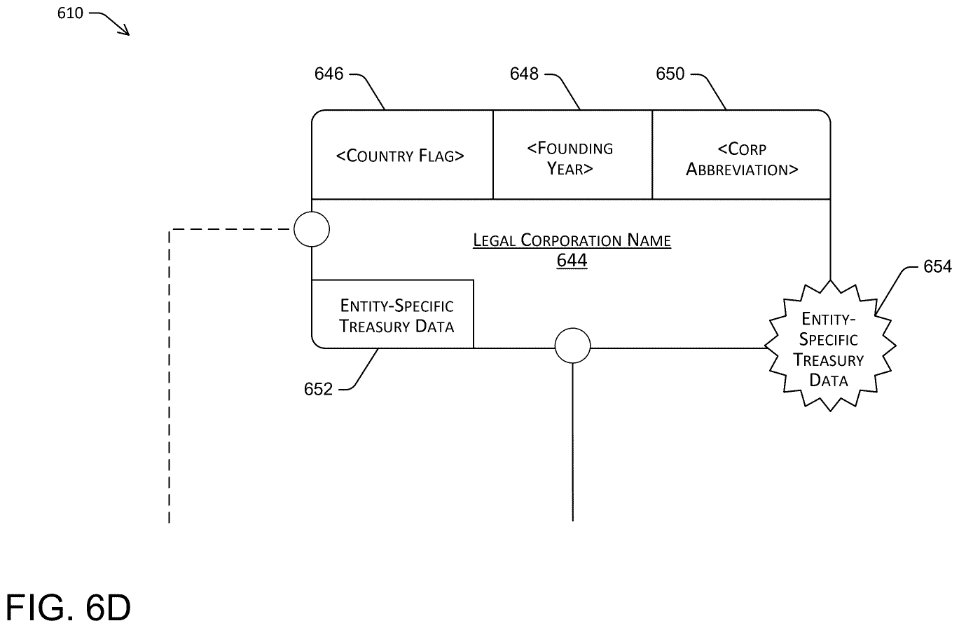

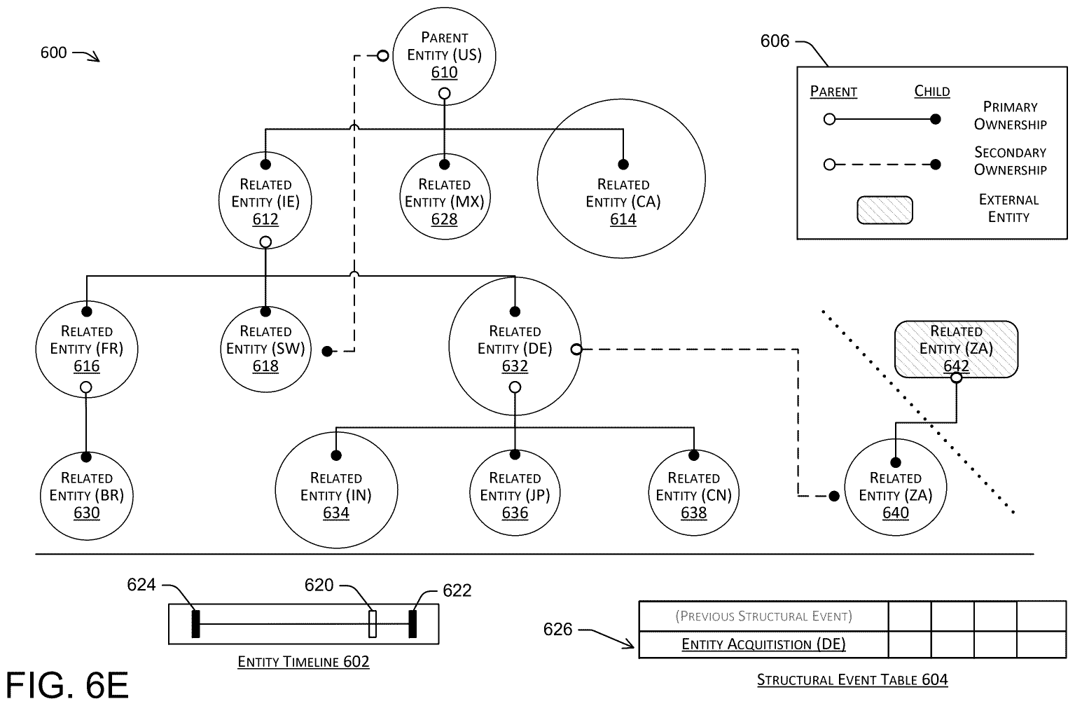

FIGS. 6A-6E depict examples of a temporal entity graph generated by a temporal entity tracking system. As noted above, one or more components of the platform system 102 (e.g., the entity manager 108) may be configured to provide various graphical views (or other output data formats) of entity data including periodicity. For instance, FIGS. 6A-6D display a temporal entity graph 600 configured to render a structural representation of a selected entity and a set of related entities, at a particular time as requested by a user input. As shown in these examples, the entity manager 108 may retrieve various types of entity-related data (e.g., legal/corporate structure data, accounting or financial data, tax data, currency balance data, employee data, transaction data, exposure risk data, etc.) from treasury data store(s) 112. The entity-related data may be temporal and/or static entity data, and may be stored in a storage system similar or identical to the data storage architecture 400B. As described in this example, a user may request (e.g., via the user interface, API, automated process, or other communication channels) a snapshot of a legal/corporate structure of an entity at a previous time. In response, the entity manager 108 may access a first data store to determine the set and structure of entities related to the requested entity at the requested time, and then may access a second data store to retrieve the requested additional entity-related data (e.g., accounting data, tax data, financial data, employee data, risk data, currency balance data, etc.) for each of the requested entity and the related entities at the requested time.

In FIG. 6A, the temporal entity graph 600 includes a graphical representation of the state of a particular entity at a particular previous time. As described above, the temporal entity graph 600 may include representations of a requested (or primary) legal or corporate entity, and the set of additional entities related to the primary entity at the requested time. The primary entity and additional related entities may be rendered on the graph as nodes, with connections between the entities depicted as edges on the graph. Thus, the temporal entity graph 600 may be stored and/or traversed as a graph database structure in some cases. In this example, the temporal entity graph 600 is displayed within an interactive graphical user interface including the graph 600, an entity timeline 602 that can be manipulated via the user interface, a table 604 of structural events relating to the entity, and a key 606 providing additional information about the nodes (e.g., external versus internal entities) and the edges (e.g., defining parent/child and primary/secondary ownership relationships). Although in this example, the temporal entity graph 600 and related components are output via a graphical UI, in other examples, the entity manager component 108 may generate and output temporal entity graphs in different (e.g., non-GUI) formats, such as data tables, etc.

In this example, temporal entity graph 600 includes a number of nodes 610-618, each node representing a separate legal/corporate entity, along with edges defining the legal relationships between the entities. In this example, a user (or a client process) may select a parent entity 610 as the primary entity on which the temporal entity graph 600 will be based. It should be understood that the selected entity need not be a parent entity, but can be any entity having additional related legal entities and/or associated treasury data that can be retrieved and rendered on the graph. The user (or client process) in this example also may use the entity timeline 602 to select a previous time 620 during the life of the parent entity 610. As shown, the previous time 620 may be selected as any time between the current time 622 and the initial time at which the parent entity 610 was created.

As described above, based on the selection of the parent entity 610 and the previous time 620, the entity manager 108 may retrieve the set of additional entities 612-618 related to the parent entity 610 at the previous time 620, determine the structural relationships between the parent entity 610 and/or the additional entities 612-618, and render the graph 600 via the user interface.

In some examples, rather than selecting a particular time via the entity timeline 602, the user may select a particular structural event 626 associated with the parent entity 610. When a particular structural event 626 is selected from the structural event table 604, the entity manager 108 may retrieve the set of additional entities 612-618 related to the parent entity 610 at the time immediately after the structural event 626 was completed, determine the structural relationships between the parent entity 610 and/or the additional entities 612-618, and render the graph 600 via the user interface. Thus, in various examples one or both of an entity timeline 602 and/or a structural event table 604 may be implemented to allow the user to explore the life of the selected entity.

Additionally, after the primary entity and additional related entities have been determined, the entity manager 108 may retrieve and render via the temporal entity graph 600 any combination of additional treasury data for the entities. As discussed above, the entity-related treasure data may include any combination of accounting data, tax data, financial data, employee data, risk data, currency balance data, and the like, for the parent entity 610 and the additional entities 612-618 at the requested time. In order not to obscure the features of this temporal entity graph 600, no additional entity-related treasury data is shown in FIG. 6A. However, various examples of overlaying or otherwise rendering entity-related treasury data into a temporal entity graph 600 are described below in reference to FIGS. 6D and 6E.

In FIG. 6B, the temporal entity graph 600 includes an updated graphical representation of the state of the parent entity 610 at a different time. In this example, user input received via the user interface (or in other examples, via an API call, automated process or service invocation, etc.), a selection of an updated time 620 via the entity timeline 602, and/or a selection of a different structural event 626 via the structural event table 604 for the parent entity 610. Although the time period represented in FIG. 6B is after the time period represented in FIG. 6A, it can be understood that the user interface (and/or related techniques) may allow for any amount of forward or backward movement in the timeline or event table of the entity in any order.

In response to the selection of the new updated time 620 and/or new structural event 626, the entity manager 108 has updated temporal entity graph 600 in FIG. 6B to include an additional new set of related entities 628 and 630, and new relationships between the various entity. In this example, the temporal entity graph 600 may reflect the results of one or more new legal entity creations and/or dissolutions, legal entity restructuring or reorganizing, acquisitions by or mergers with the parent entity 610, etc.

FIG. 6C depicts another update to the temporal entity graph 600, representing the updated state of the parent entity 610 at another different time. In this example, additional input received by the entity manager 108 may include yet another selection of an updated time 620 via the entity timeline 602, and/or another selection of a different structural event 626 via the structural event table 604 related to the parent entity 610. In response to the selection of the new updated time and/or new structural event, the entity manager 108 has updated temporal entity graph 600 again in FIG. 6C to include an additional new set of related entities 632-642 (including an external entity 642 not related to the parent entity 610), and new relationships between the various entity. As in the previous example, the updated temporal entity graph 600 may reflect the results of one or more new legal entity creations and/or dissolutions, legal entity restructuring or reorganizing, acquisitions by or mergers with the parent entity 610, etc. Along with selecting various different times in these examples, the temporal entity graph 600 may allow users to select different entities, which upon selection may become the primary entity for the graph. For instance, if a user selects the related entity 640 via the user interface, the temporal entity graph 600 may be updated to center on the related entity 640 as the primary entity. In this example, the entity manager 108 also may determine an updated set of additional entities associated with the new primary entity, update the entity timeline 602 and the structural event table 604 based on the life of the new primary entity, etc.

As noted above, the nodes in the temporal entity graph 600 may be overlaid with any number of treasury-related data fields for each of the entities displayed in the graph. In various examples, the node representing the parent entity 610 and/or any or all other nodes within the graph 600 may include various combinations of labels, graphics, visual characteristics, and the like, to represent any number of different treasury-data fields for their respective entities. For instance, FIG. 6D depicts an example of a more detailed view of the graphical node representing the parent entity 610. In this example, the node for the parent entity 610 display a number of different data fields within the node, including the legal corporation name 644, a country flag 646 representing the country in which the parent entity 610 is legally registered, the founding year 648 of the parent entity 610, and the corporate abbreviation (e.g., ticker symbol) of the parent entity 610. Additionally or alternatively, the node may include any number of different treasury-data fields 652-654 which are entity-specific to the legal entity represented by the node. Although not shown in this example, the entity manager 108 also may determine different attributes or characteristics for the graphical representations of the different nodes in the graph 600 based on certain treasury-data fields for the respective entities. For instance, the size, shape, color, font, graphical icons, or any other visual characteristics of the nodes may be determined based on the treasury data retrieved for the respective entities.

FIG. 6E depicts one example of determining the graphical representations of the nodes in the temporal entity graph 600 based on the treasury data of the respective entities. In this example, each node is represented as a circle with a size based on one or more treasury data attributes (e.g., cash balance, foreign currency, risk exposure, etc.) of the entities at the specific previous time that the graph represents. To illustrate, the circle sizes in this example may represent the respective cash balances of the different entities at the previous time 620. To determine and render the nodes with the appropriate circle sizes, the entity manager 108 may initially determine the relative cash balances for all of the entities depicted in the current view, and may scale the node sizes appropriately to accurately represent the differences in cash balances while also managing the placement and configuration of the nodes based on the available screen space in the user interface. In other examples, other visual attributes such as node colors, different node shapes, font types and sizes, graphical icons, etc., may be used individually or in combination to represent one or any combination of treasury-data. As these examples illustrate, the temporal entity graph 600 as depicted in FIGS. 6A-6E may provide additional advantages for analyzing multiple dimensions and elements of entity data in a single coherent user interface view. At a glance, a user may view the temporal entity graph 600 in FIG. 6E to identify the entity structure and entities related to the parent entity 610 at the selected time, and to view the relative cash balances (and/or other relative treasury data comparisons) across the network of related entities.

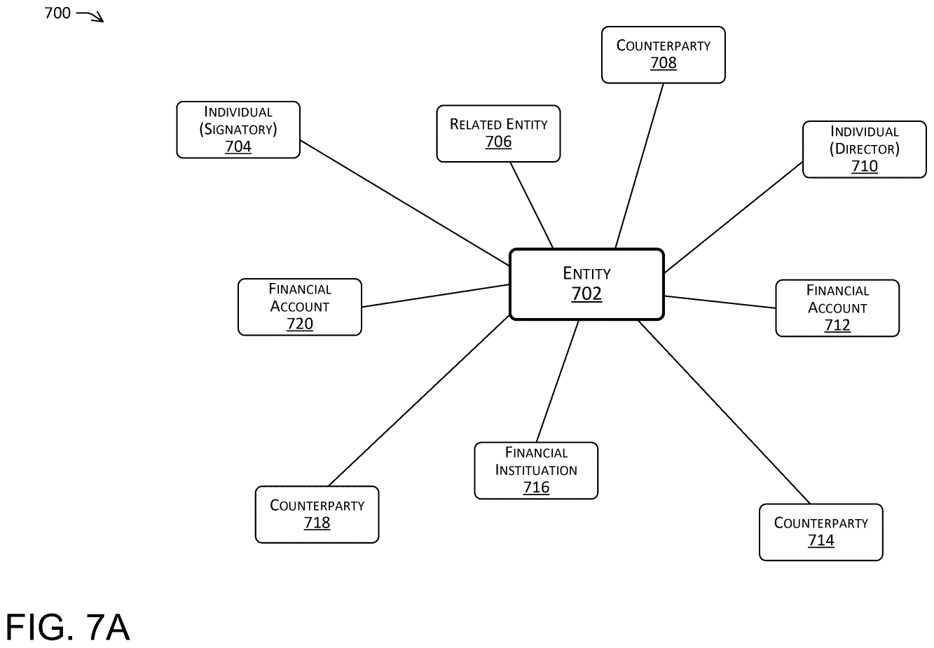

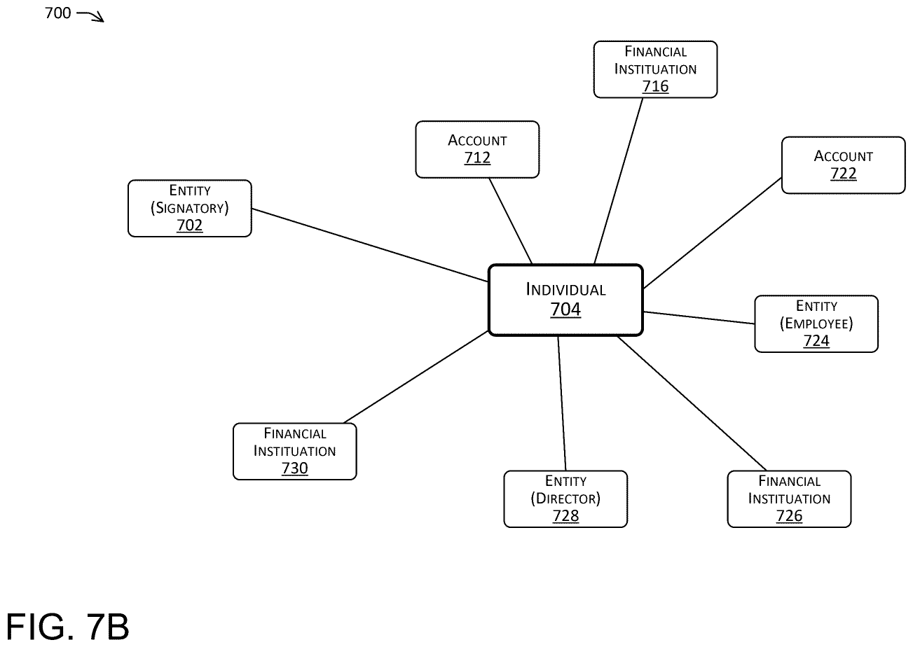

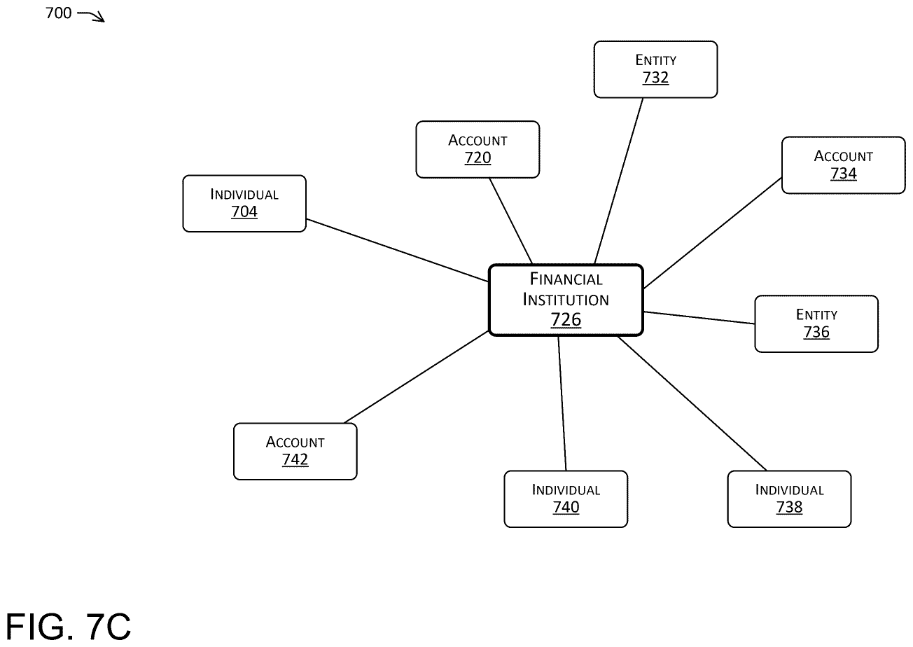

FIGS. 7A-7C depict an example of a relationship graph 700 representing various relationships between one or more legal/corporate entities and any number of related entity attributes. As described below in more detail, the relationship graph 700 may be centered on a primary node representing an entity, individual, account, counterparty or third party. The primary node may be rendered in a central location within the relationship graph 700, and a number of additional nodes may be rendered on the graph representing other entities, individuals, accounts, counterparties or third-party entities that are connected by one degree of separation from the primary node. As shown below, the relationship graph 700 may be rendered in an interactive user interface (e.g., separately or in conjunction with the temporal entity graph 600) in which users may traverse the relationship graph 700 to see the first-degree relationships between the various objects the legal/corporate entity landscape.

In at least the examples shown in FIGS. 7A-7C, an entity may refer to a registered legal and/or corporate entities for which various treasury data is stored in the treasury data stores 112. Entities may be associated with various other entities, individuals, accounts, counterparties, etc. For example, the temporal entity graph 600 depicts a number of parent-child relationships between related entities (e.g., corporations, partially or fully owned subsidiaries, holding companies, etc.) in a corporate structure. Entities also may be associated with individuals of various roles, for which entity-related data may be stored in the treasury data stores 112. The individuals associated with an entity may include its employees, directors, officers, board members, and signatories, each of which may have different defined roles and authorizations with respect to the entity. Additionally, entities may be associated with accounts (e.g., financial accounts, merchant accounts, governmental accounts for corporate or tax purposes, etc.). Entities also may have business relationships with other corporate entities to which they are not legally related, such as counterparty to a corporate transaction or a financial exchange, a third-party bank at which the entity has an account, a third-party registration service or tax provider, etc.

While a primary entity may have relationships with other various objects or constructs, as described above, including related entities, non-legally related business entities, individuals, accounts, etc., these other objects or constructs may have additional relationships independent of their relationships with the primary entity. For instance, an individual who serves as a board member for a first corporate/legal entity may serve as a signatory and employee for a second entity and a board member for a third entity, etc. Such individuals also may be associated with accounts (e.g., as owners, signatories, etc.), and/or counterparties (e.g., as employees, board members, etc.), and/or financial institutions (e.g., as customers, account holders, etc.). Similarly, an account and/or financial institution may have associations with multiple different legal/corporate entities, individuals, third-parties, etc.

FIGS. 7A-7C illustrate an example of a relationship graph 700 including nodes representing entities and/or other objects (e.g., accounts, individuals, counterparties, banks, etc.). Although these examples depict first-degree connections (e.g., relationships within one degree of separation), in other examples a relationship graph 700 may show multi-degree connections covering any number of degrees of separation. Additionally, although the nodes in the relationship graph 700 in FIGS. 7A-7C are not shown displaying any additional entity-related treasury data, so as not to obscure the figures, in some examples any or all of the nodes within a relationship graph 700 may be rendered to overlay or otherwise include any combination of treasury-related data fields. For instance, such rendering may include displaying different type-specific data fields for entity nodes (e.g., entity size, sales/revenue, cash balance, exposure risk, etc.), individual nodes (e.g., number of previous/current board memberships, signatory authorities, direct reports, etc.), account nodes (e.g., size of account, age or activity of account, number of associated entities/signatories, etc.), and/or counterparty/third-party nodes (e.g., numbers of customers, size of accounts or businesses, etc.)

In FIG. 7A, the relationship graph 700 includes a central entity node 702 associated with an entity managed by the platform system 102 and/or entity manager 108. In some examples, the relationship graph 700 may be rendered graphically with a primary node (e.g., the entity node 702 in FIG. 7A) rendered centrally and/or differently (e.g., larger, different shape, coloring, and/or font, etc.) from the other nodes in the graph. Each other node 704-720 shown in FIG. 7A represents an additional entity or object that is related to or otherwise associated with the entity represented by the entity node 702. For example, individual node 704 represents a signatory of the entity, entity node 706 represents a related entity (e.g., subsidiary or parent company) of the entity, counterparty node 708 represents a counterparty of the entity, individual node 710 represents a director of the entity, account node 712 represents a financial account of the entity, counterparty node 714 represents another counterparty of the entity, third-party entity node 716 represents a financial institution of the entity, counterparty node 718 represents another counterparty of the entity, account node 720 represents another financial account of the entity.

In some examples, the relationship graph 700 may be provided within the same user interface as the temporal entity graph 600 described above. For instance, selecting (e.g., right-clicking) on an entity within the temporal entity graph 600 and/or selecting a menu option may cause the entity manager 108 to render a relationship graph 700 for the selected entity. In other examples, the temporal entity graph 600 and the relationship graph 700 may be rendered separately and independently.

In FIG. 7B, the relationship graph 700 has been modified based on a selection (e.g., click) or other user input via the user interface. In this example, the individual node 704 has been selected. As noted above, the individual represented by the individual node 704 serves as a signatory for the entity 702. However, the individual is also associated with a number of additional entities, accounts, etc., and may serve in a number of different roles with respect to these additional entities or objects.

In response to the selection of the individual node 704 in the relationship graph 700, the entity manager may perform transform the graph into an updated graph view with the individual node 704 as the primary node. To transform the graph the entity manager 108 may query any or all data stores within the platform system 102 to determine the additional relationships and/or associations between the individual and any other entities or objects represented in the system. The entity manager 108 then may update the nodes within the relationship graph 700, including removing nodes, adding new nodes, repositioning nodes, and/or retrieving and rendering treasury-related data associated with the nodes. For instance, in FIG. 7B a number of new nodes 722-730 have been rendered, and the additional nodes have been repositioned around the individual node 704. In some cases, the rendering of a non-primary node may be based on data associated with the node itself, as well as based on the type of association that the non-primary node has related to the primary node. For instance, the graphical representation of the new entity node 724 may indicate that the relationship of the individual relative to the entity (e.g., an employee), and a similar indication may be included in the new entity node 728 (e.g., director), etc.

In FIG. 7C, the entity manager 108 has performed another transformation on the relationship graph 700, in response to a selection of the financial institution node 726. As in the previous example, after the financial institution node 726 is selected via the user interface in FIG. 7B, the entity manager 108 may query one or more treasury data stores 112 to determine any number of relationships or association between the financial institution and any other entities, individuals, accounts, etc. The entity manager 108 may then update the nodes within the relationship graph 700, including adding, removing, and repositioning nodes, and then rendering the updated set of nodes with the financial institution node as the primary node. As illustrated in these examples, the relationship graph 700 provides advantages in analyzing and visualizing the legal/corporate landscape associated with an entity or network of related entities. The interactive functionality of the relationship graph 700 further allows for easy traversal of relationships between shared accounts, signatories, directors, financial institutions, counterparties, etc.

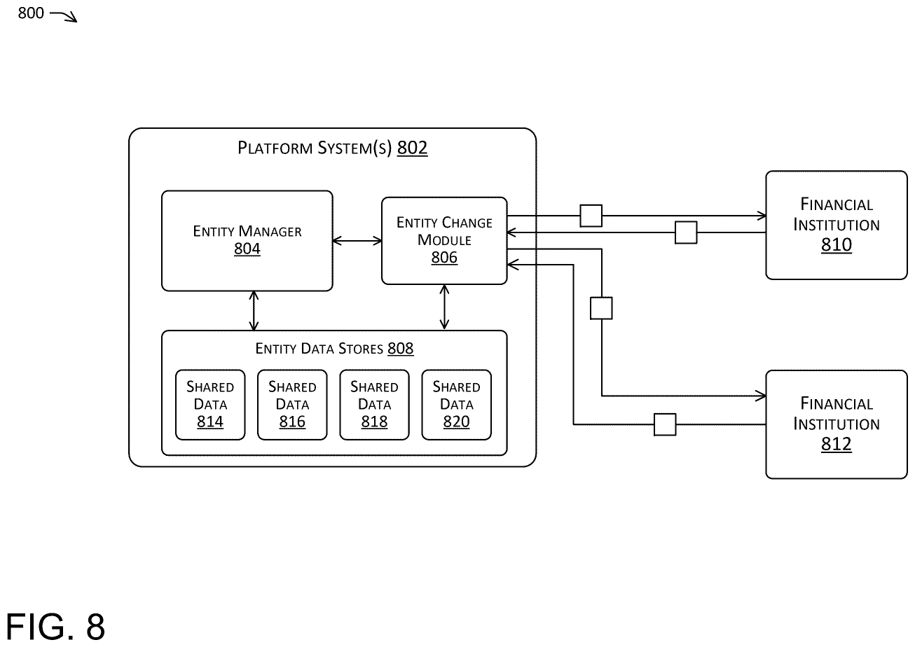

FIG. 8 shows an example implementation of a system 800 configured to automatically share entity data between a platform system 802 and one or more financial institutions 810-812. In some examples, the system 800 may be an entity sharing data system in which, in response to events or certain data states, the entity manager 804 may automatically provide particular subsets of entity data to particular financial institutions 810. The entity manager 804 also may request automated responses and/or other entity-related data from the financial institutions 810, in response to particular events occurring on the external computing systems of the financial institutions 810.

In the example depicted in FIG. 8, the platform system 802 may correspond to (e.g., may be similar or identical to) the platform system 102 for treasury data described in the above examples, the entity manager 804 may correspond to the entity manager 108 described above, and the entity data stores 808 may correspond to any combination of the treasury data store(s) 112 described above. The financial institutions 810 may be implemented as separate and independent third-party systems residing on separate data centers, clouds, and/or networks than the platform system 802. Additionally, although this example relates to financial institutions 810, in other examples the system 800 may be configured to automatically provide (and/or receive) subsets of entity data to (and/or from) any counterparty or other external system authorized to exchange entity data with platform system 802.

As shown in this example, the platform system 802 may perform automated data tracking and notifications based on subsets of shared entity-related data. For instance, the entity manager 804 may be configured to determine and manage different subsets 814-820 of shared data between the (internal) entity data stores 808 of the platform system 802, in which each data subset 814-820 may be associated/shared with one or more external systems such financial institutions 810 and/or 812. The change module 806 may be configured to track the data within the shared data subsets 814-820, to determine when any of the shared has changed. In response to a change of data within a shared data subset 814-820, the entity manager 804 may automatically provide the updated data records to the external systems. Additionally, the entity manager 804 may request notifications from the external systems when providing the updated data, for instance, notifications to be provided with the external systems completes an update or task related to the changed data.

In some examples, the entity manager 804 may define the particular subsets of relevant entity-related data to be shared with particular external systems. For instance, any data changes (e.g., additions, removals, modifications) to the shared data subset 814 may be provided to the first financial institution 810, and any data changes to the shared data subset 816 may be provided to the second financial institution 810, etc. Each of the shared data subsets 814-820 can include any combination of data fields, tables, databases, etc., and may be stored as separate copies of the data within the entity data stores 808 or may be stored as reference tables including links to the shared data fields within the storage architecture of the entity data stores. Each shared data subset 814-820 also can be shared within a single external system or any combination of multiple external systems (e.g., a financial institution server, a corporate registry service, a governmental system, a third-party tax services provider system, etc.).

As one example, a shared data subset 814 may include a set of officers and signatories associated with a particular corporate entity. When any of the officers or signatories leaves the company, the financial institution 810 may be required to update the ownership and/or signatory data on any number of accounts. In this example, in response to an officer (e.g., a CFO) leaving the company, the entity change module 806 may detect the change to the shared entity data, and may provide the updated records for the data subset 814 to the financial institution 810 (and/or other any entities that may be required to update their systems). In this example, financial institution 810 also may transmit data back to the entity manager 804, such as data confirming that the accounts associated with the entity have been updated based on the changed set of officers, signatories, etc.

In another example, the shared entity data 814 may include a set of subsidiaries associated with a corporate entity, and the dissolution of one or more of the subsidiaries may cause the entity manager 804 to provide the updated shared entity data 814 to the financial institution 812. In response to receiving the notification of the subsidiary dissolution, the financial institution 812 may be required to close and/or transfer one or more accounts. Requested actions such as opening, closing, or modifying accounts may remain pending until they are completed by the financial institution 812, after which the updated account information (e.g., account types, numbers, statuses, balances, etc.) may be transmitted back to the platform system 802.

In some cases, either or both systems associated with a shared subset of entity data (e.g., the platform system 802 and the financial institution 810) may be configured to automatically accept and integrate the updated data records into their systems. Additionally or alternatively, the systems associated with a shared entity data may include the functionality to provide a received data update to the user via a user interface, and to allow the user to review and accept/reject the updated data before it is inherited into its own data stores. This may provide the advantage of automating and/or expediting various processes that otherwise must be performed fully or partially manually within both systems. Additional advantages of these techniques include improved data security of entity-related data. For instance, the entity manager 804 and/or the entity data stores 806 may represent a central and secure data repository for any of the entity-related data described herein. Within the entity data stores 806, the entity manager 804 can determine different portions of treasury data associated with particular entities to be shared with the financial institutions 810-812 (or other external systems) associated with those particular entities, without allowing external systems with direct access to the entity data stores 806 and without exposing or transmitting any additional data that is not specifically designated to be shared with the external system(s). These techniques further enable a seamless data exchange and straight-through process for allowing the entity manager 804 and external partner systems to determine all required tasks to be performed with respect to the external systems, whenever any entity data change occurs. In various examples, the shared data subsets may be provided using various formats and/or various different data transfer technologies (e.g., graphical interfaces, APIs, and/or file transfer interfaces such as FTP).

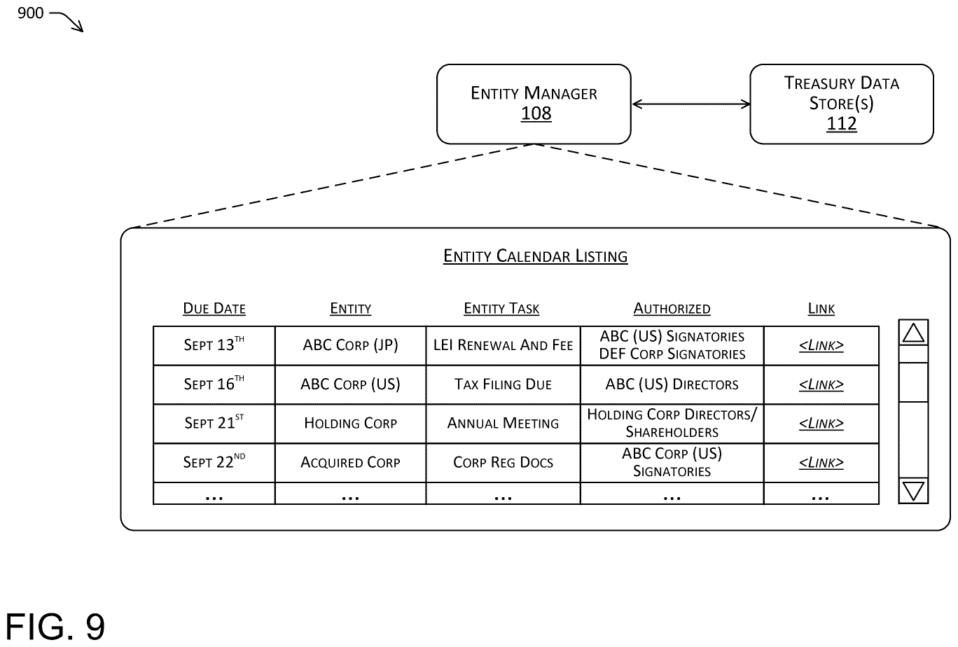

FIG. 9 depicts an example user interface 900 of calendar listing associated with an entity (or a network of related entities). In this example, the entity manager 108 may be configured to mine the treasury data store(s) 112 for any corporate/legal documentation associated with the entity and/or related entities, to generate a calendar of required or suggested tasks to be performed associated with the entities. The automated task detection and calendaring can be performed for tasks such as corporate entity renewals, required filings, meetings, and/or other tasks or events. As shown in this example, a single calendar may be generated and ordered chronologically that includes a number of required or recommended tasks associated with an entity and any number of related (e.g., parent and/or child) entities.

In some examples, different subsets of entity calendar listing for a network of related entities may be generated for different corporate departments and/or users (e.g., a legal tasks calendar, a tax task calendar, etc.). Additionally, the entity manager 108 may be configured to provide automated notifications for any tasks within the entity calendar listing, in which the notifications may be provided to the specific personnel that are authorized to perform the particular task. Such notifications may be customized with respect to the notification type (e.g., text, email, app-based notification, etc.), and the list of recipients and/or departments that receive the notifications. In some examples, the entity calendar listing and/or notifications associated with task items may include links to the relevant interfaces (e.g., internal or third-party web pages or services) and/or links to the relevant documents to allow the authorized individuals to quickly perform the required task.

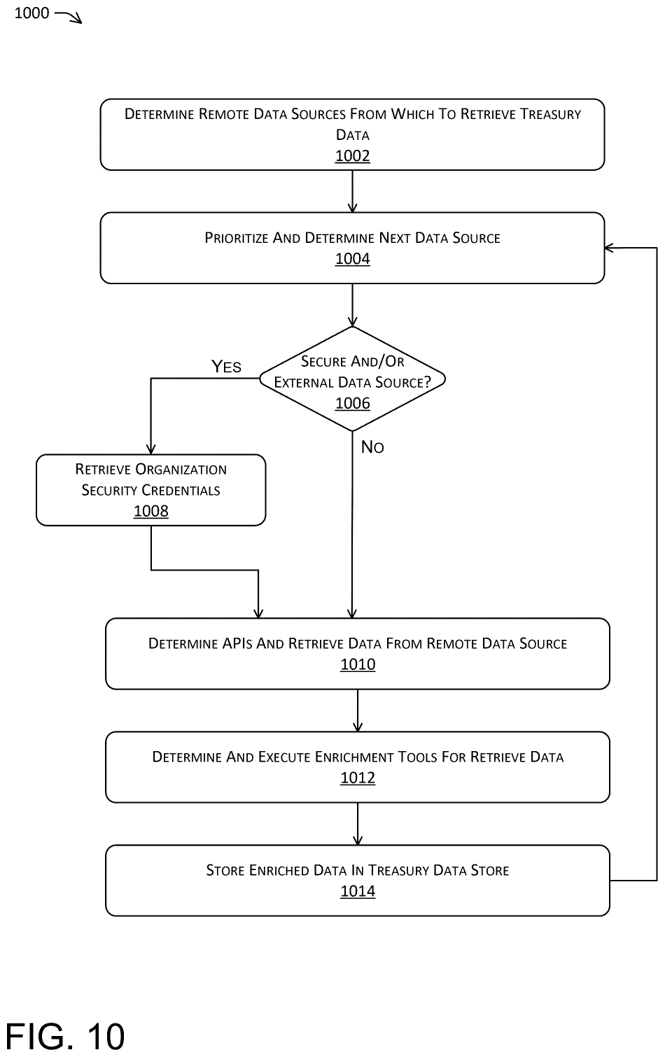

FIG. 10 shows a flow diagram illustrating an example process 1000 of receiving and enriching data from various data sources associated with a treasury analytics cloud platform system. In various examples, process 1000 may be performed by one or more computing devices and systems configured to implement the functionality of a cloud-based treasury system 102, including a data enrichment component 104 and/or a treasury data store(s) 112 as described below.

At operation 1002, the cloud-based treasury system 102 associated with an organization may determine one or more remote data sources from which to retrieve treasury data. In some examples, the cloud-based treasury system 102 (e.g., the data enrichment component 104, APIs, and/or other data retrieval component) may initiate the retrieval of data from data sources 202-220. For instance, the cloud-based treasury system 102 may determine a subset of the data sources 202-220 relevant to the treasury data of the organization, and may periodically request updated data from each of the relevant data sources. The subset of data sources 202-220 that are relevant to a cloud-based treasury system 102 may include any data sources storing treasury data associated with or relevant to the organization in general, and/or any data sources storing organization-related treasury data that is used by one or more data analytics or BI tools in the analytics component 106. As an example, if the analytics component 106 of the cloud-based treasury system 102 does not currently have any requests, BI tools, or scheduled data analytics to execute that use input data from certain data sources (e.g., a financial institution, merchant system, public registry, etc.), then the cloud-based treasury system 102 may exclude those data sources from the set of data sources determined in operation 1002.

At operation 1004, the cloud-based treasury system 102 may prioritize and determine a next data source from which to request updated treasury data. In some examples, the cloud-based treasury system 102 may determine schedules for periodically retrieving data updates from each of the relevant data sources 202-220. The schedules may be predetermined (e.g., hourly, daily, etc.), or may be triggered based on an event at the cloud-based treasury system 102, such as a request for updated data, executing the data analytics and/or BI tools, or based on a determination that the existing data state of the treasury data store(s) 112 has become stale. In other examples, the data sources 202-220 themselves may initiate data retrieval, for instance, by triggering an API 222-224 of the organization in response to determining that a data update has occurred within the remote data source of data relevant to the organization.

At operation 1006, the cloud-based treasury system 102 may determine whether or not the data source is a secure and/or external data source. When the cloud-based treasury system 102 determines that the data source is an internal data source (e.g., on a private network or with the computing infrastructure of the organization) and/or a public external data source such as public registry data, exchange rate, or interest rate data, public market data, etc. (1006: No), then the cloud-based treasury system 102 may determine that no additional security credential is needed and the process may proceed to operation 1010.

In contrast, when determining that the data source is a secure and/or external data source (e.g., a third-party banking system) (1006: Yes), then at operation 1008 the cloud-based treasury system 102 may retrieve one or more network identifiers and security credentials to allow the cloud-based treasury system 102 to access the data source on behalf of the organization and retrieve data associated with the organization.

At operation 1010, the cloud-based treasury system 102 may determine one or more APIs (and/or other access interfaces) to use to retrieve data from the data source. As described above, in some cases the API may be a double-layer API including an API gateway layer (or other API layer configured to handle security and authentication), and a second API layer with the logic for retrieving, transporting, and storing the data.

At operation 1012, the cloud-based treasury system 102 may determine (or select) and execute one or more enrichment software tools based on the data retrieved in operation 1010. As described above, enrichment tools may include various different types of software-based tools (e.g., tools 302-304) including rules engines and/or trained models to analyze, transform, and organize the received data. In some cases, data enrichment tools may classify certain data based on text descriptions, metadata, etc., and organize data by type/class to support more efficient and robust analytics. The data enrichment tools also may determine associations between matching or corresponding data from different data sources, so that separate data records or objects can be linked as relating to the same asset, same transaction, same entity, etc.

Finally, at operation 1014, the cloud-based treasury system 102 may store the enriched data in one or more treasury data store(s) 112. As noted above, the data stored in the treasury data store(s) 112 may be organized using schemas based on the analytics component 106, using treasury-centric data structures and data stores, and cross-referencing of data dependencies to allow for more robust and efficient execution of data analytics and BI tools.

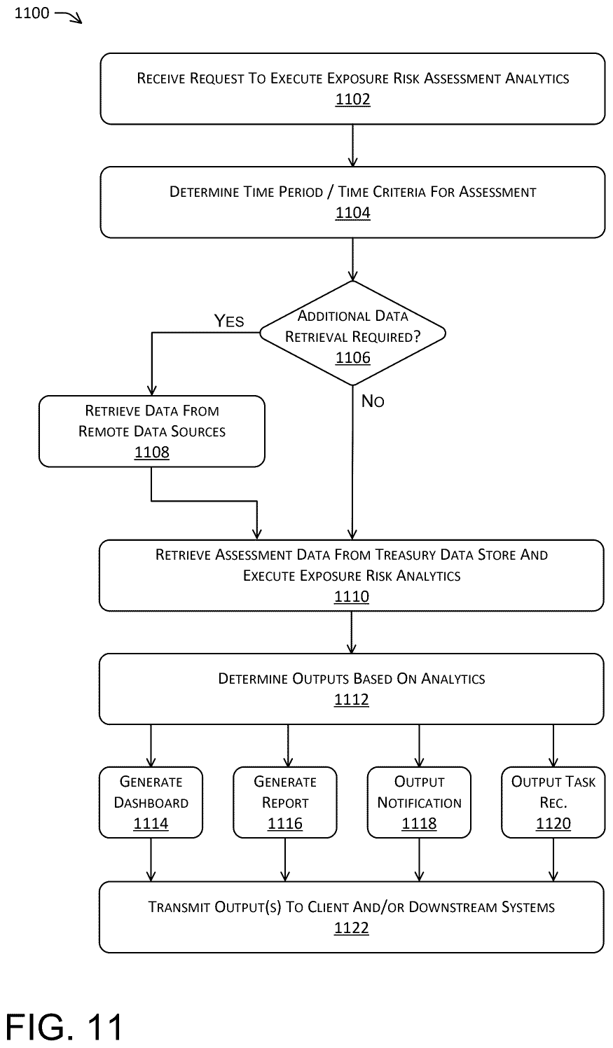

FIG. 11 shows a flow diagram illustrating an example process 1100 of using a treasury analytics cloud platform system to execute exposure risk data analytics associated with an organization. In various examples, process 1100 may be performed by one or more computing devices and systems configured to implement the functionality of a cloud-based treasury system 102, including a data enrichment component 104, analytics component 106, and/or interfaces 110, along with a treasury data store(s) 112 storing treasury-related organization data.

At operation 1102, the cloud-based treasury system 102 may receive a request to execute data analytics (and/or a BI tool) to determine an exposure risk assessment. The request in operation 1102 may be initiated based on a request for a dashboard, report generation, notification registration, or the like, received via a client device 122 or downstream system 124. In other examples, the request may be based on a predetermined and scheduled analytics run. As noted above, the particular data metric(s) requested (e.g., exposure risk metrics) may determine which analytics and/or BI tools from the analytics component 106 are to be executed. Although this example describes analytics to determine exposure risks metrics (e.g., foreign exchange exposure, currency exposure, interest rate exposure, etc.), in other examples the request in operation 1102 may relate to any other cloud-based analytics or organization management solution.

At operation 1104, the cloud-based treasury system 102 may determine one or more time periods and/or time-based criteria associated with the analytics request. For example, a time period may be a current assessment of the exposure risk of the organization, or may be a historical analysis from a previous time to compare past and present exposure risk metrics. As noted above, the treasury data store(s) 112 may be configured to store archived treasury data for the organization, to support analytics on historical data, perform trend analyses, etc. Additionally, a time-based criteria may refer to the degree of recency of the data. In some examples, a request for a current assessment of the exposure risk may require the cloud-based treasury system 102 to retrieve updated data from one or more data sources (e.g., data sources 202-220) to comply with a time-based criteria.

At operation 1106, the cloud-based treasury system 102 may determine whether or not additional data is required to be retrieved and/or enriched, before the requested analytics can be executed. When the cloud-based treasury system 102 determines that additional data from data sources is not required (1106: No), then the system may proceed to operation 1110 to execute the requested analytics. In contrast, when determining that additional data may be required to execute the requested data analytics and/or comply with the requested time period or criteria (1106: Yes), then at operation 1108 the cloud-based treasury system 102 may retrieve the required data from one or more data sources. In some cases, operation 1108 may include similar or identical operations to those in process 600 described above, and may be performed for one or multiple internal and/or external data sources. The particular data sources from which the data is retrieved in operation 1108 may depend on the treasury data that is used as input by the data analytics and/or BI tools requested in operation 1102.

At operation 1110, the cloud-based treasury system 102 may select and execute one or more data analytics processes and/or BI tools from the analytics component 106, based on the requested metrics or assessments in operation 1102. Execution of the data analytics and/or BI tools may include retrieving the corresponding treasury data for the organization (e.g., for the requested time period) from the treasury data store 112.

At operation 1112, the cloud-based treasury system 102 may determine that one or more outputs are to be provided to client devices 122 and/or downstream systems 124, based on the output from the data analytics and/or BI tools executed in operation 1110. In some cases, if the output(s) from operation 1110 do not satisfy a predetermined criteria, then the cloud-based treasury system 102 might not provide any output. For instance, if an exposure risk metric does not meet or exceed a risk threshold, then the cloud-based treasury system 102 may take no further action.

However, in other cases, the cloud-based treasury system 102 may provide output data to one or more client devices 122 or downstream systems 124, based on the exposure risk metrics determined in operation 1110. As shown in this example, the output data may be provided via a dashboard in operation 1114, a report in operation 1116, a notification 1118 based on a previous notification request, and/or a task recommendation 1120 output to a task engine. Finally, at operation 1122, the cloud-based treasury system 102 may transmit the various output data to the client devices 122 and/or downstream systems 124, thereby providing the results of the exposure risk assessment analytics for the organization, to the specified entities and in the specified digital format associated with the request.

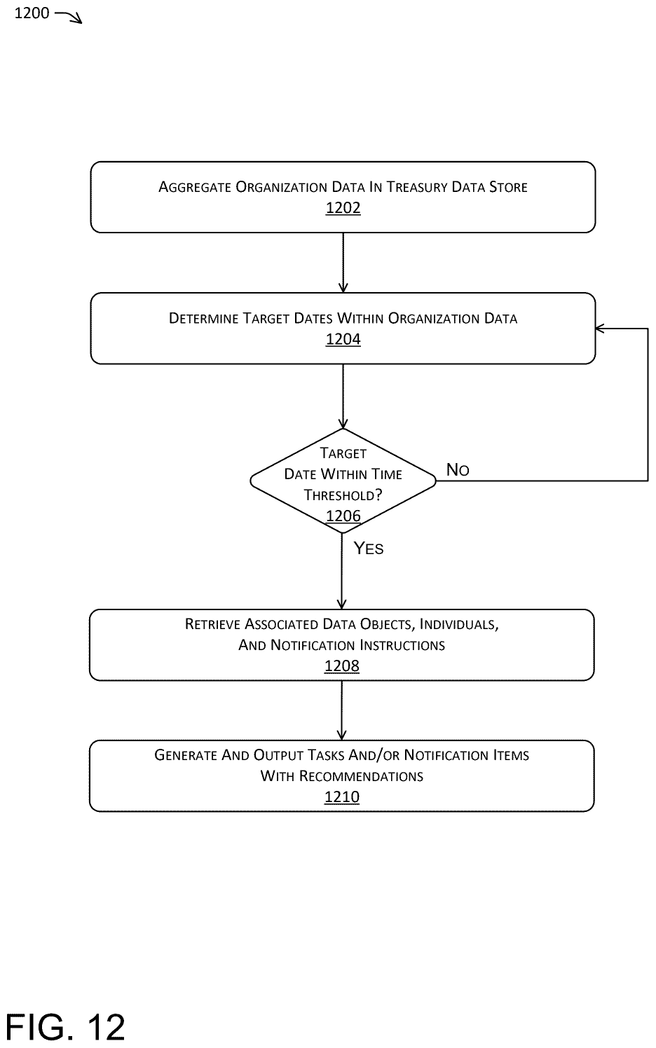

FIG. 12 shows a flow diagram illustrating an example process 1200 of detecting and generating date-driven outputs based on organization-related and/or treasury-related data within a cloud platform system. As described above for processes 1000 and 1100, process 1200 may be performed a cloud-based treasury system 102, including a data enrichment component 104, analytics component 106, and/or interfaces 110, along with a treasury data store(s) 112 storing treasury-related organization data.

At operation 1202, the cloud-based treasury system 102 may aggregate treasury data associated with an organization, from multiple different data sources, into the treasury data store(s) 112. At operation 1204, the cloud-based treasury system 102 may analyze the aggregated treasury data with the treasury data store(s) 112, to determine target dates associated with individual treasury data items. Target dates may include, for example, renewal dates, expiration dates, termination dates, value dates, maturity dates, and the like. Various types of target dates may be associated with individuals, entities, transactions, accounts, exchanges, and/or any other treasury data.

At operation 1206, the cloud-based treasury system 102 may determine whether any of the target dates determined in operation 1204 are within a time threshold for outputting an alert or performing other actions based on the target date. In some examples, the time threshold may include a recency time threshold based on the current time (e.g., within the next day, week, two weeks, month, etc.). When none of the target dates within the treasury data for the organization satisfy the time threshold (1206: No), then process 1200 may return to operation 1204 to determine and analyze additional target dates.

In contrast, when a target date associated with the organization treasury data satisfies the time threshold (1206: Yes), this indicates a date-driven event within the organization treasury data. As described above, target dates may correspond to upcoming renewal dates, expiration dates, termination dates, value dates, maturity dates, etc. Date-driven events may correspond to an action to be performed (e.g., an optional or mandatory action) by the organization on or before the target date. For instance, date-driven events may include requirements to submit a renewal application or pay fee, requirements to file a form, requirements to submit a payment or complete a transaction, and the like, which the organization may want or need to perform before the target date.

After determining that a target date identified within the organization treasury data satisfies the time threshold (1206: Yes), then in operation 1208 the cloud-based treasury system 102 may retrieve additional data from the treasury data store(s) 112 associated with the date-driven event. For instance, for a license renewal requirement event, the cloud-based treasury system 102 may retrieve additional data associated with the license object, such as the individual licensee, the subsidiary, one or more signatories, an associated payment account, and the like.

Finally, at operation 1210, the cloud-based treasury system 102 may generate and output one or more tasks or notifications, based on the date-driven event. As shown in this example, tasks or notifications may be generated by the system, assigned to one or more individuals or entities associated with the event, and then submitted to a task engine or a notification engine. In various examples, date-driven events also may be collected, grouped, and presented passively to users via client devices 122 or downstream systems 124, within reports or via dashboard interfaces.

As noted above, although some examples herein relate to using analytics and BI tools to determine exposure risks, in other examples similar cloud-based analytics systems and techniques may be implemented to execute analytics or BI tools for analyses of other treasury data metrics and/or analyses within any other distributed data system.

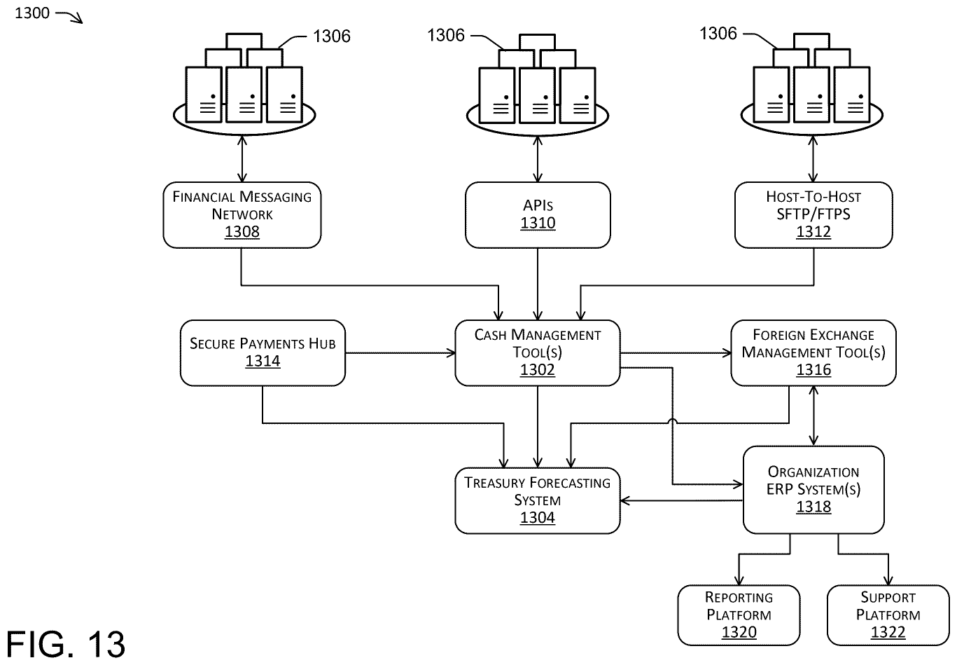

For example, referring now to FIG. 13, an example system 1300 is shown for executing cash management data analytics associated with a cloud-based treasury system 102. In some examples, some or all of the functional components within system 1300 may be implemented as an analytics process or software tool within the analytics component 106 of the cloud-based treasury system 102. For instance, the cash management tool(s) 1302 and/or treasury forecasting system 1304 may include heuristics-based algorithms and/or trained machine-learned models to determine and forecast organization cash management metrics, based on various treasury data of the organization, stored within the treasury data stores(s) 112.

In this example, datacenters 1306 may be associated with banks or other financial institutions. A financial message network 1308 may provide financial data associated with the organization to the cash management tool(s) 1302. Additionally or alternatively, APIs 1310 (e.g., implemented via REST, JSON, etc.), and or an Internet-based host-to-host secure file transfers protocol (SFTP) connectivity technique 1312 may be used to provide financial data from the datacenters 1306 to the cash management tool(s) 1302. In some examples, the communications between the datacenters 1306 and the cash management tool(s) 1302 may include data messaging and processing techniques, including translation and data enrichments as described above, via the cloud-based treasury system 102.

To execute the cash management data analytics as shown in this example, the secure payments hub 1314 may provide payment messaging and/or other files associated with payments to the cash management tool(s) 1302. The cash management tool(s) 1302 then may provide non-functional currency denominated cash and/or investment balances, including payments, and/or foreign exchange currency conversions reflected on bank statements, to the foreign exchange management tool(s) 1316. The cash management tool(s) 1302 in this example also may provide historical bank statement balances and/or transaction activity, to the treasury forecasting system 1304. The secure payments hub 1314 also may provide historical and pending payment activity to the treasury forecasting system 1304, and the foreign exchange management tool(s) 1316 may provide historical foreign exchanges exposure balances to the treasury forecasting system 1304.

Continuing with this example, the cash management tool(s) 1302 may provide bank statement balance data and/or transaction activity to an internal organization ERP system 1318. The ERP system 1318 then may provide general ledger journal entries, and total cost and fixed cost balances to the foreign exchange management tool(s) 1316. The ERP system 1318 also may provide accounts payable and accounts receivable subledger activity to the treasury forecasting system 1304, as well as providing general ledger balances and transactions into the reporting platform 1320 (or other consolidation system) and into the support platform 1322 (e.g., an accounting close and audit support platform).

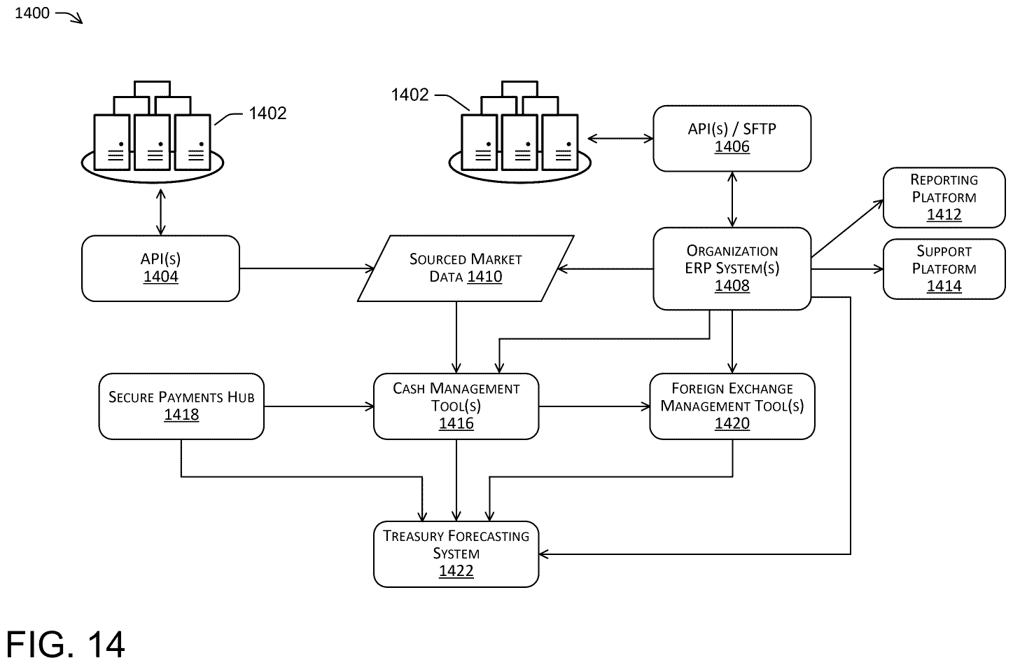

Referring now to FIG. 14, another example system 1400 is shown for executing foreign exchange data analytics associated with the cloud-based treasury system 102. As in the above example, some or all of the functional components within system 1400 may be implemented as an analytics process or software tool within the analytics component 106 of the cloud-based treasury system 102. For instance, the cash management tool(s) 1416 and/or treasury forecasting system 1422 may include heuristics-based algorithms and/or trained machine-learned models to execute foreign exchange data analytics, based on various treasury data of the organization, stored within the treasury data stores(s) 112.

In this example, market data may be retrieved from one or more market data vendors 1402, via APIs and/or SFTP connectivity 1406, and provided to the organization ERP system(s) 1408. The organization ERP system(s) 1408 may provide general ledger balances, transactions, and imported market data to the reporting platform 1412 (or other consolidation system) and the support platform 1414 (e.g., an accounting close and audit support platform). In this example, the organization ERP system(s) 1408 also may provide general ledger journal entries and balances to the foreign exchange management tool(s) 1420. The ERP system(s) 1408 also may import accounting foreign exchange rates and/or other sourced market data, into the cloud-based treasury system 102.

Additionally, third-party market data 1410 received via APIs 1404, from market data vendors 1402, may be imported into the cloud-based treasury system 102. The market data 1410 may be published for all organizations in some cases, or for specific organizations based on their respective market data vendor licensing agreements. The market data 1410 may be provided to any components with the systems 1300 (e.g., the cloud-based treasury system 102), including but not limited to the secure payments hub 1418, the cash management tool(s) 1416, foreign exchange management tool(s) 1420, and the treasury forecasting system 1422.

Continuing with this example, the secure payments hub 1418 may provide payments messaging and/or other files associated with payments to the cash management tool(s) 1416, to be used for positioning. The secure payments hub 1418 and cash management tool(s) 1416 may provide data to the foreign exchange management tool(s) 1420 to be used for exposure analytics. The secure payments hub 1418, cash management tool(s) 1416, the foreign exchange management tool(s) 1420, and the organization ERP system(s) 1408 also may provide their respective treasury data to the treasury forecasting system 1422, which may be used as input data for the analytics and/or BI tools executed by the treasury forecasting system 1422.

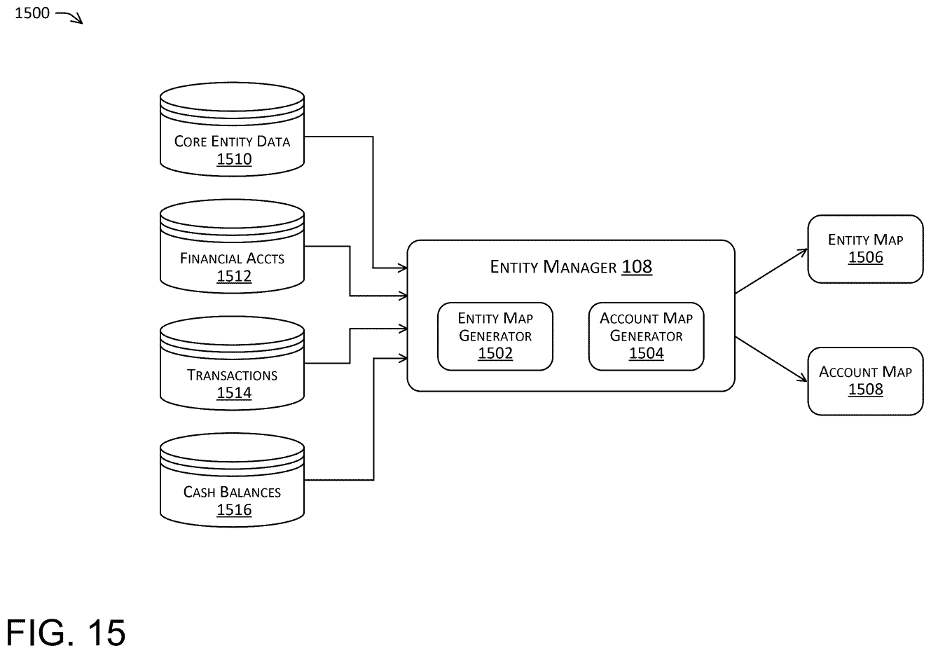

Referring now to FIG. 15, and example computing environment 1500 is shown, including an entity manager with components configured to generate entity maps and/or account maps associated with entities. In this example, the entity manager 108 may be similar or identical to the entity manager 108 describe in the various other examples herein. The entity manager 108 may be associated with an organization, and may be programmed to collect, store, and manage entity-related data associated with the organization (e.g., including the organization itself and/or other relevant entities associated with the treasury system of the organization). As noted above, the entity-related data received and analyzed by the entity manager 108 may include data associated with the organization itself, subsidiaries and/or parent companies of the organization, as well as the individuals, departments, and the like associated with the organization. The entity manager 108 also may receive data associated with one or more partner entities related to the organization, such as customers, suppliers, merchants, banks, accounting firms, investing firms, etc.

As shown in this example, the entity manager 108 may include an entity map generator component 1502 and an account map generator component 1504. These components may be respectively configured to generate an entity map 1506 and/or account map 1508 based on the various entity-related data received by the entity manager 108. In this example, the entity manager 108 receives entity-related data from a core entity data source 1510, a financial accounts data source 1512, a transactions data source 1514, and a cash balances data source 1516. Although only these data sources are show in the example computing environment 1500, as described above the entity manager may receive data from any number of other additional data sources. Such additional data sources may include any of the entity data sources 408-418 and/or data stores 420-426 described above. Further, although data sources 1510-1516 are depicted as individual data sources, in various examples the entity manager 108 may receive data from multiple separate and independent financial account data sources 1512, multiple separate and independent transaction data sources 1514, and so on.

The entity map generator component 1502 may be configured to generate and an entity map 1506. As discussed above, an entity map may include an interactive user interface (and/or other graphical views) that visualizes a set of related entities. In various examples, an entity map 1506 may provide a tool for visualization and exploring the entity details associated with an organization, its various subsidiaries, parents, and/or other related entities, including providing periodicity as (e.g., via a temporal entity graph) as described above in reference to FIGS. 6A-6F.

The account map generator component 1504 may be configured to generate and account maps 1508 associated with one or more entities. An account map 1508 may include an interactive user interface (and/or other graphical views) allowing users to visualize and explore the account-to-account relationships between the various accounts associated with an entity. Based on the underlying input data, including entity relationships, financial accounts, transaction data, and cash balance data, the account map generator component 1504 may determine relationships between pairs (or any grouping of two or more) accounts associated with an entity. With respect to accounts, a relationship may refer to one or more instances of funds between transferred between the accounts. The account map generator component 1504 may determine account-to-account relationships by analyzing the movement of funds between the accounts, including the amount, frequency, and directionality of the transfers, as well as the mechanisms by which the funds were transferred (e.g., automatically via a standing wire, or via manual funds transfers). After determining the account-to-account relationships, the account map generator component 1504 then may construct a graphical data structure, with accounts represented as nodes and edges determined based on the transfers of funds between accounts.

In some examples, an account map 1508 may include representations of all the accounts associated with an entity (e.g., including all the accounts owned by the entity, parent entities, subsidiaries, related foreign entities of the organization, etc.). Additionally or alternatively, an account map 1508 may be generated to include only the accounts involved in money transfers with other accounts of the entity. Examples of account-to-account relationships that may be determined by the account map generator component 1504 and visualized in an account map 1508 may include relationships in which a first account (e.g., a lock-box or deposit account) is periodically swept into a second bank account of the entity, two-way transfer relationships in which a first account funds a second account with a loan and the second account pays down the loan (e.g., a revolving loan), relationships between merchant accounts that receive and accumulate inbound credit card payments which are periodically swept into a bank account of the entity, and/or relationships between accounts holding one type of currency (e.g., US dollars) and related accounts holding a different type of current in a foreign country.

To generate an account map 1508 associated with an entity (and/or group of related entities), the account map generator component 1504 may use a combination of automated and manual techniques to analyze the input data (e.g., financial account data, transactions, cash balances, etc.) in order to determine the account-to-account relationships to be visualized within the user interface of the account map 1508. For instance, the account map generator component 1504 may determine a relationship between accounts (one-way or bidirectional) based on identifying a threshold number of money transfers and/or threshold transfer amount between the accounts. In some cases, the account map generator component 1504 may identify patterns associated with the transfers, including detecting periodic schedule-based transfers between accounts (e.g., a standing wire) and/or event-based transfers between the accounts (e.g., based on a number of merchant transactions, when an account balance reaches a threshold value, etc.). The account map generator component 1504 may implement heuristics-based algorithms and/or trained machine-learned (ML) models configured to identify relationships between accounts and/or determine characteristics of the account-to-account relationships. For instance, the account map generator component 1504 may trained ML models to detect account-to-account relationships and determine the characteristics of the relationships, based on account data, transaction data, and/or cash balance data within the set of entity accounts over a period of time.

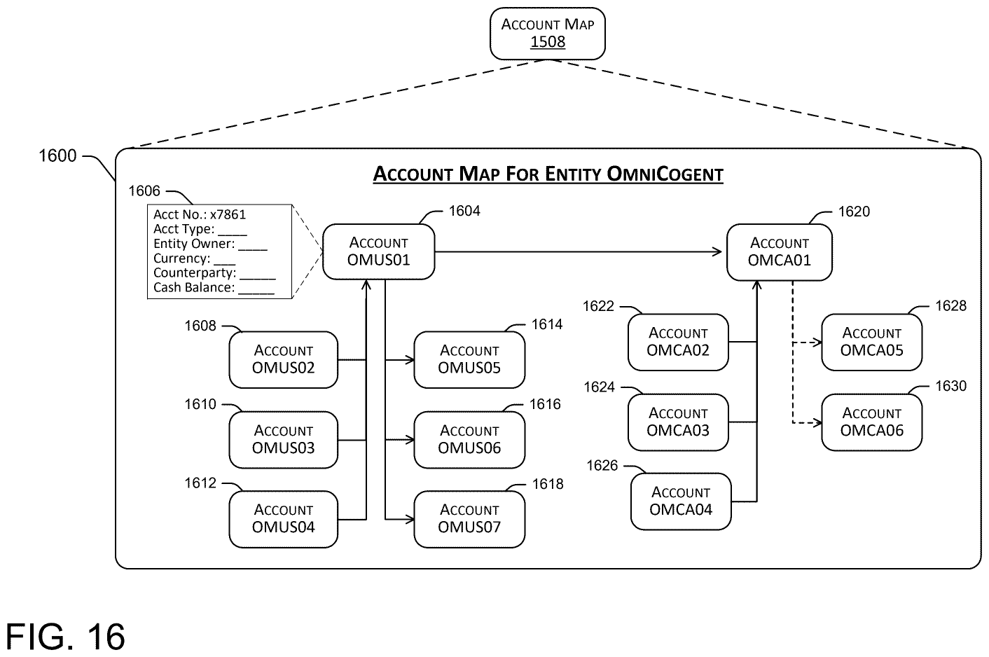

Referring now to FIG. 16, example user interface 1600 generated based on an account map 1508 is shown for an example entity (e.g., “OmniCogent”). As shown in this example, the account map user interface 1600 includes a set of nodes visually rendered on the user interface, where each node represents a financial account owned by the entity (e.g., including accounts owned by related entities). In this example, each node in the user interface 1600 may display various account information, either within the default view of the user interface or in response to a user action, such as an on-click node selection, mouseover, etc. The information that may be displayed or otherwise available for each account via the user interface can include the account number, entity/entities that own the account, the type of account, the account currency, the counterparty to the account, and/or the current or previous balances of the account. In this example, a first account node 1604 (“OMUS01”) has been selected, causing a popup window 1606 to be displayed within the user interface, the popup window 1606 displaying various account information associated with the OMUS01 account of the entity. Any of the additional account nodes 1608-1630 can be similarly selected/expanded to allow the user to view the account information of the associated accounts.

The account map user interface 1600 also includes arrows connecting the pairs of account nodes determined by the account map generator component 1504 to have a relationship. As noted above, account-to-account relationships may be determined based on detecting funds transfers between the accounts, and the arrows rendered within the account map user interface 1600 may be based on the characteristics of the funds transfers. For instance, the account map generator component 1504 may determine whether the funds transfers between the accounts are automated (e.g., via a standing wire) and/or manual, and also may determine the direction, frequency, amounts, and/or other characteristics of the of the funds transfers, to determine the characteristics of the arrows to be rendered within the user interface 1600. Examples may include rendering unidirectional or bi-directional arrows based on the directionality of the funds transfers between two accounts, rendering the color and/or thickness of the arrows based on the frequency and/or amount of the transfers, rendering the color and/or style of the arrows based on whether the transfers or automated or manual, etc.

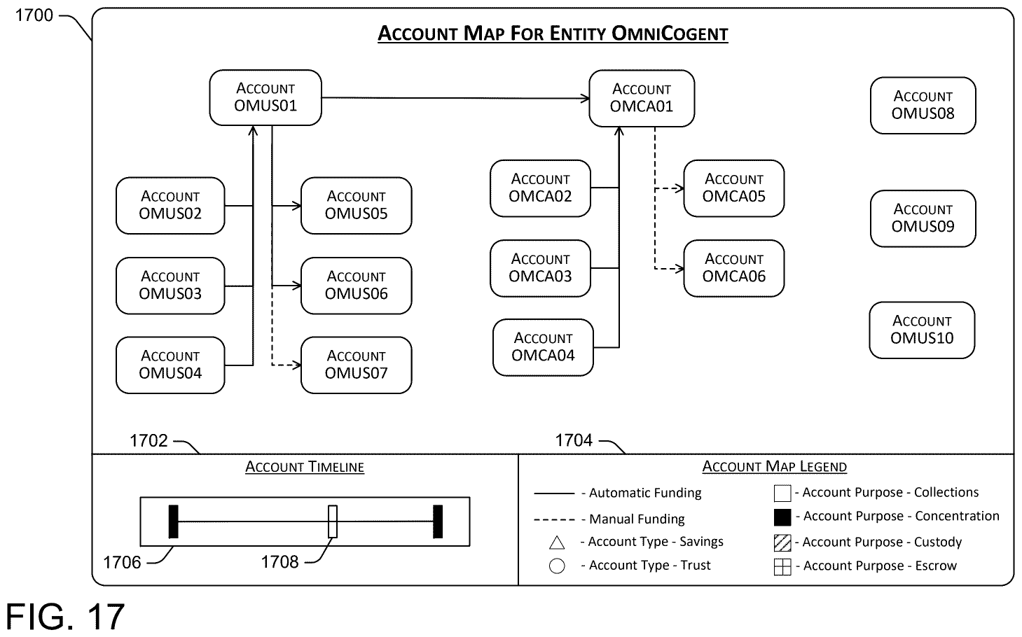

Referring now to FIG. 17, another example account map user interface 1700 is shown, illustrating a number of additional features that may be included with account maps in various examples. In this example, the account map user interface 1700 may provide periodicity, by allowing the user to view the account map for the entity at different points in time during the history of the entity's accounts. For instance, the account map user interface 1700 includes an account timeline feature 1702 including a timeline slider component 1706 that may be manipulated via the user interface to select different times during the life of the entity. As shown in this example, the timeline slider component 1706 may be manipulated via a moveable slider bar 1708, which can be positioned to representing any time between the current time and the initial time at which the entity's first account was created. The techniques for supporting periodicity within the account map user interface 1700 may be similar or identical to the techniques for supporting periodicity within the entity maps described above. For instance, the various input data used to generate the account maps (e.g., financial account data, associated entity data, account cash balances, transaction data, etc.) may be retrieved and analyzed for various different points in time for the entity. As the user manipulates the moveable slider bar 1708, the account map user interface 1700 may be updated automatically to add or remove account nodes, change the account data/attributes associated with each account node, change the arrows representing the account-to-account relationships displayed within the user interface, etc.

The account map user interface 1700 also includes an account map legend 1704. As shown in this example, the account map legend 1704 may define the associations between the account boxes and arrows rendered in the account map user interface 1700, and the corresponding characteristics of the underlying accounts and the account-to-accounts relationships as determined by the account map generator component 1504. As shown in this example, the account map legend 1704 may define different arrow characteristics for automatic (e.g., standing wire) versus manual funding. The account map legend 1704 also may define different visualization techniques for the account nodes rendered in the user interface, based on the corresponding account types. For instance, each of the following account types may be visualized differently within the account map user interface 1700: corporate credit card accounts, crypto wallet accounts, custody accounts, demand deposit accounts, derivative trading accounts, escrow accounts, investment accounts, merchant services accounts, savings accounts, and trust accounts. Additionally, the account map legend 1704 may define different visualization techniques for the account nodes based on the determined purpose of the account. For each of the following account purposes may be visualized differently within the account map user interface 1700: collections accounts, concentration accounts, custody accounts, escrow accounts, investments brokerage accounts, merchant services A/R accounts, operating accounts, payables accounts, payables (Bill.com) accounts, payables (Billtrust) accounts, payables (Expensify) accounts, payroll accounts, capital contribution accounts, ESPP contribution accounts, intracompany funding accounts, reconciliation accounts, sweep activity accounts, tax payments accounts, etc. The different visualization techniques within the account may user interface 1700 for representing different account types, account purposes, and/or other account characteristics may include, but is not limited to the use of different colors, styles, shapes fonts, background patterns, and the like for rendering the various account nodes.

The methods, systems, and devices discussed above are examples. Various configurations may omit, substitute, or add various operations (or method steps) or procedures, or system components as appropriate. For instance, in alternative configurations, the methods may be performed in an order different from that described, and/or various stages or steps or modules may be added, omitted, and/or combined. Also, features described with respect to certain configurations may be combined in various other configurations. Different aspects and elements of the configurations may be combined in a similar manner. Also, technology evolves and, thus, many of the elements are examples and do not limit the scope of the disclosure or claims.

Specific details are given in the description to provide a thorough understanding of example configurations (including implementations). However, configurations may be practiced without these specific details. For example, well-known circuits, processes, algorithms, structures, and techniques have been shown without unnecessary detail in order to avoid obscuring the configurations. This description provides example configurations only, and does not limit the scope, applicability, or configurations of the claims. Rather, the preceding description of the configurations will provide those of skill with an enabling description for implementing described techniques. Various changes may be made in the function and arrangement of elements without departing from the spirit or scope of the disclosure.

Also, configurations may be described as a process depicted as a flow diagram or block diagram. Although each may describe the operations as a sequential process, many of the operations may be performed in parallel or concurrently. In addition, the order of the operations may be rearranged. A process may have additional steps not included in the figure. Furthermore, examples of the methods may be implemented by hardware, software, firmware, middleware, microcode, hardware description languages, or any combination thereof. When implemented in software, firmware, middleware, or microcode, the program code or code segments to perform the necessary tasks may be stored in a non-transitory computer-readable medium such as a storage medium. Processors may perform the described tasks.

Furthermore, the examples described herein may be implemented as logical operations in a computing device in a networked computing system environment. The logical operations may be implemented as: (i) a sequence of computer-implemented instructions, steps, or program modules running on a computing device; and (ii) interconnected logic or hardware modules running within a computing device.

Although the subject matter has been described in language specific to structural features and/or methodological acts, it is to be understood that the subject matter defined in the appended claims is not necessarily limited to the specific features or acts described above. Rather, the specific features and acts described above are disclosed as example forms of implementing the claims.

What is claimed is:

1. A temporal entity tracking system comprising:
one or more processors; and
one or more computer-readable media storing computer-executable instructions that, when executed, cause the one or more processors to perform operations comprising:
receiving a request including an entity identifier associated with a first entity, and time data representing a previous time;
determining, based at least in part on the entity identifier and the time data, a plurality of additional entities related to the first entity at the previous time;
retrieving, from one or more entity data stores, previous entity data for each of the plurality of additional entities, wherein the previous entity data is associated with the previous time;
generating, responsive to the request, an entity graph associated with the first entity, the entity graph comprising a plurality of nodes and a plurality of edges connecting the plurality of nodes, wherein generating the entity graph comprises:
generating, for each particular entity of the plurality of additional entities, a node associated with the particular entity, based at least in part on the previous entity data for the particular entity; and
generating, for each particular entity of the plurality of additional entities, one or more edges associated with the particular entity, based on one or more relationships between the particular entity and the first entity or the plurality of additional entities; and
outputting the entity graph.

2. The temporal entity tracking system of claim 1, wherein determining the additional entities related to the first entity at the previous time comprises:
performing a first query of a data store to determine a second entity associated with the first entity at the previous time; and
performing a second query of the data store to determine a third entity associated with the second entity at the previous time.

3. The temporal entity tracking system of claim 1, wherein generating the entity graph further comprises:
determining a graphical representation associated with each of the plurality of nodes, wherein at least one of a size, a shape, or a color of the graphical representation for each particular node is based on the previous entity data associated with the particular node.

4. The temporal entity tracking system of claim 1, the operations further comprising:
receiving, via a user interface on which the entity graph is displayed, updated time data associated with a second previous time different from the previous time;
determining a second plurality of additional entities related to the first entity at the second previous time;
retrieving second previous entity data for each of the second plurality of additional entities, wherein the second previous entity data is associated with the second previous time; and
updating the entity graph displayed via the user interface, the updating comprising at least one of:
rendering a new node onto the entity graph, based on the second plurality of additional entities;
removing at least one node from the entity graph, based on the second plurality of additional entities; or
updating a graphical representation of an existing node on the entity graph, based on the second previous entity data.

5. The temporal entity tracking system of claim 4, wherein retrieving the second previous entity data comprises:
determining a dynamic data field associated with the first entity;
determining a static data field associated with the first entity; and
querying the one or more entity data stores to retrieve an updated value for the dynamic data field, wherein the querying does not include querying the static data field.

6. The temporal entity tracking system of claim 1, the operations further comprising:
receiving, via a user interface on which the entity graph is displayed, a selection of a structural event associated with the first entity;
determining a second plurality of additional entities related to the first entity, based at least in part on the structural event;
retrieving second previous entity data for each of the second plurality of additional entities, based at least in part on the structural event; and
updating the entity graph displayed via the user interface, the updating comprising at least one of:
rendering a new node onto the entity graph, based on the second plurality of additional entities;
removing at least one node from the entity graph, based on the second plurality of additional entities; or
updating a graphical representation of an existing node on the entity graph, based on the second previous entity data.

7. The temporal entity tracking system of claim 1, the operations further comprising:
receiving, via a user interface on which the entity graph is displayed, a selection of an individual associated with the first entity;
determining, at least one additional entity associated with the individual;
determining, at least one entity attribute associated with the individual; and
updating the entity graph displayed via the user interface, the updating comprising:
rendering a central node on the entity graph associated with the individual;
rendering a node on the entity graph for each of the at least one additional entity; and
rendering a node on the entity graph for each of the at least one entity attribute.

8. The temporal entity tracking system of claim 1, the operations further comprising:
receiving, via a user interface on which the entity graph is displayed, a selection of an entity attribute associated with the first entity;
determining, at least one additional entity associated with the entity attribute;
determining, at least one individual associated with the entity attribute; and
updating the entity graph displayed via the user interface, the updating comprising:
rendering a central node on the entity graph associated with the entity attribute;
rendering a node on the entity graph for each of the at least one additional entity; and
rendering a node on the entity graph for each of the at least one individual.

9. The temporal entity tracking system of claim 1, wherein determining the plurality of additional entities related to the first entity comprises:
determining an initial entity relation state associated with the first entity at an initial time;
receiving a list of structural events associated with the first entity; and
traversing the list of structural events, in chronological order, from the initial time to the previous time.

10. The temporal entity tracking system of claim 1, wherein:
determining the plurality of additional entities related to the first entity comprises accessing a first temporal data store storing legal entity relationships; and
retrieving the previous entity data comprises accessing a second temporal data store storing entity operating data.

11. A method comprising:
receiving, via a user interface, a request including an entity identifier associated with a first entity, and time data representing a previous time;
accessing a first data store to determine, based at least in part on the entity identifier and the time data, a second entity related to the first entity at the previous time;
accessing a second data store to determine first previous entity data associated with the first entity and second previous entity data associated with the second entity, wherein the first previous entity data and the first previous entity data are associated with the previous time;
generating, via the user interface, an entity graph associated with the first entity, the entity graph comprising at least a first node representing the first entity and a second node representing the second entity, and at least one edge connecting the first node and the second node; and
rendering the entity graph via the user interface.

12. The method of claim 11, wherein determining the second entity related to the first entity at the previous time comprises:
performing a first query of the first data store to determine the second entity associated with the first entity at the previous time; and
performing a second query of the first data store to determine a third entity associated with the second entity at the previous time.

13. The method of claim 11, wherein generating the entity graph further comprises:
determining graphical representations of the first node and the second node, wherein at least one of a size, a shape, or a color of the graphical representations for the first node and the second node is based on the first previous entity data and the second previous entity data.

14. The method of claim 11, further comprising:
receiving, via the user interface, updated time data associated with a second previous time different from the previous time;
determining a third entity related to the first entity at the second previous time;
retrieving third previous entity data for the third entity and updated first previous entity data for the first entity, wherein the third previous entity data and the updated first previous entity data are associated with the second previous time; and
updating the entity graph rendered via the user interface, the updating comprising at least one of:
rendering a new node onto the entity graph, based on the third entity;
removing the second node from the entity graph, based on the second entity; or
updating a graphical representation of the first node on the entity graph, based on the updated first previous entity data.

15. The method claim 14, wherein determining the first previous entity data comprises:
determining a dynamic data field associated with the first entity;
determining a static data field associated with the first entity; and
querying the second data store to retrieve an updated value for the dynamic data field, wherein the querying does not include querying the static data field.

16. The method of claim 11, further comprising:
receiving, via the user interface, a selection of a structural event associated with the first entity;
determining a third entity related to the first entity, based at least in part on the structural event;
retrieving third previous entity data for the third entity, based at least in part on the structural event; and
updating the entity graph rendered via the user interface, the updating comprising at least one of:
rendering a new node onto the entity graph, based on the third entity;
removing the second node from the entity graph, based on the second entity; or
updating a graphical representation of the first node on the entity graph.

17. The method of claim 11, further comprising:
receiving, via the user interface, a selection of an individual associated with the first entity;
determining, at least one additional entity associated with the individual;
determining, at least one entity attribute associated with the individual; and
updating the graph rendered via the user interface, the updating comprising:
rendering a central node on the graph associated with the individual;
rendering a node on the graph for each of the at least one additional entity; and
rendering a node on the graph for each of the at least one entity attribute.

18. The method of claim 11, further comprising:
receiving, via the user interface, a selection of an entity attribute associated with the first entity;
determining, at least one additional entity associated with the entity attribute;
determining, at least one individual associated with the entity attribute; and
updating the graph rendered via the user interface, the updating comprising:
rendering a central node on the graph associated with the entity attribute;
rendering a node on the graph for each of the at least one additional entity; and
rendering a node on the graph for each of the at least one individual.

19. The method of claim 11, wherein determining the second entity related to the first entity comprises:
determining an initial entity relation state associated with the first entity at an initial time;
receiving a list of structural events associated with the first entity; and
traversing the list of structural events, in chronological order, from the initial time to the previous time.

20. The method of claim 11, wherein the request is received at a current time after the previous time, and wherein the second entity is not related to the first entity at the current time.
